(19) United States
(12) Patent Application Publication
(10) Pub. No.: US 2011/0289105 A1
(43) Pub. Date: Nov. 24, 2011

(54) FRAMEWORK FOR CONDUCTING LEGAL RESEARCH AND WRITING BASED ON ACCUMULATED LEGAL KNOWLEDGE

(75) Inventor: Ari Hershowitz, Palo Alto, CA (US)

(73) Assignee: Tabulaw, Inc., San Francisco, CA (US)

(21) Appl. No.: 12/944,940

(22) Filed: Nov. 12, 2010

Related U.S. Application Data
(60) Provisional application No. 61/345,822, filed on May 18, 2010.

(51) Int. Cl. G06F 17/30

(52) U.S. Cl. 707/769; 707/E17.014

(57) ABSTRACT

Disclosed herein is a framework for conducting legal research, writing, and collaboration tasks and accumulating legal knowledge. The framework can contain a body of legal documents. Users can select quotations from the documents, group one or more quotations in a Quote Bundle, and add annotations to the quotations within the Quote Bundles and/or add annotations directly to the Quote Bundles. The quotations, annotations, and Quote Bundles can be shared between users. Furthermore, the Quote Bundles can be integrated with a built-in word processing tool to facilitate the writing process. As a user creates a document, one or more Quote Bundles can be displayed. A user can select a quotation from a Quote Bundle, which can then be added to their document. When a quotation is added to a user created document, the proper citation information can also be added without further action by the user.

### CROSS-REFERENCE TO RELATED APPLICATIONS

This application claims priority from U.S. Provisional Patent App. No. 61/345,822, filed May 18, 2010, and entitled “LEGAL SEARCH AND DOCUMENT CREATION SYSTEM”, and which is incorporated by reference herein for all purposes.

### BACKGROUND

1. Technical Field

The present disclosure relates to a process of conducting legal research, writing, and collaboration tasks and more specifically to a computer-implemented method for the unification of such tasks.

2. Introduction

Conducting legal research and writing legal documents based on legal research are tasks routinely performed by a significant portion of the legal community. For example, suppose a prospective client walks into a law office with a problem he would like solved. The prospective client explains his problem, but before the lawyer can suggest an appropriate course of action, she needs to explore the relevant statutes and/or case law. Additionally, the lawyer may need to prepare a number of documents based on her research. For example, she may need to prepare a memo analyzing the current law with respect to the prospective client's particular factual situation. In the event that filing a lawsuit is the chosen course of action, she may need to use her research to prepare the complaint. Additionally, throughout the course of the lawsuit, she may need to conduct further research and/or want to use her previous research to prepare additional documents such as motions or briefs. Legal research and writing is also performed in a number of other settings. For example, law students or law professors may perform these tasks when working on course assignments or when preparing a journal article. Law clerks and judges may also perform these tasks when preparing for a case or when writing a court opinion. Unfortunately, a typical legal researcher faces a number of challenges when performing these common tasks. Three of the common challenges include obtaining access to the relevant documents, efficiently searching the documents, and uniting the research and writing processes.

One of the common challenges facing legal researchers is obtaining access to the relevant legal documents, which can include statutes, regulations, federal and state case law, as well as secondary sources like law review articles. All of these documents can be found in hardcopy and/or electronic formats. Hardcopy documents have a number of drawbacks in that the legal researcher either needs to obtain their own copies, which has cost and space issues, or the researcher needs access to a publicly available source such as a library. Additionally, hard copy versions are difficult to search efficiently. For example, identifying the citation for a particular quote can be difficult without a means to narrow the search. Furthermore, as technology becomes more pervasive, some documents, like law review articles, are only available in electronic format.

There are also a number of hurdles to overcome in gaining access to legal documents in an electronic format. First, currently there is no publically available, centralized database of legal documents, which makes it difficult to search public databases efficiently. There are private commercial, centralized databases, but access to these databases can be costly. Researchers must access various sources of legal information among this fragmented landscape of databases, and currently have no efficient way of storing the information they gather.

A second common challenge facing legal researchers is searching the documents to identify those that are relevant to the legal issue. The currently available search mechanisms for electronic legal documents are painfully slow and the most important/relevant points of law are often buried among a pile of irrelevant cases. This applies to searching a centralized database, and the process is further complicated when the researcher is forced to individually search several databases. Furthermore, the searches are based on the static documents and there is no way to augment the documents based on previously conducted research so as to improve the search results.

A third significant challenge facing the legal researcher is the mismatch between legal research and writing: most of the time spent on legal research involves reading cases and copying relevant quotations from primary sources to an outside word processing program. Each legal researcher has to create his or her own system for keeping track of these quotes and their associated citations over the course of days, weeks, months, or even years. If, as often happens, a legal researcher wants to quote a longer passage from a case previously researched, the legal researcher often has to search online for the case again, search the case for the quote and determine the appropriate page citation manually.

Over time, it often occurs that a legal researcher will repeatedly perform similar searches as a result of not having a suitable process to maintain previous research results. For example, a legal researcher may remember that a particular case provides an excellent quote for some legal standard, but not remember the exact quote or the proper citation. Unless, the researcher has established a system for keeping track of this information, he or she will have to look up the case and search the case for the quote each time it is needed. Furthermore, due to the nature of legal work, over time many different legal researchers may conduct searches for similar material. However, because there is no centralized method to share past research results, the legal researchers are forced to repeat the searches. This is often even true for legal researchers within the same firm or organization.

### SUMMARY

Additional features and advantages of the disclosure will be set forth in the description which follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present technology provides mechanisms for conducting legal research, writing, and collaboration tasks and for accumulating legal knowledge. The Legal Knowledge system can include a body of legal documents and a variety of ways for users to interact with the documents.

In some embodiments, an anchor can be designated in a legal document. The anchor can be a heading, a citation, or a document passage, such as a quotation. Depending on the configuration of the system and/or the type of anchor, citation information can automatically be associated with the anchor. For example, if a quotation is selected from a legal document, the document information, page number(s) and paragraphs, sentence or word-level location information can be associated with the quotation. Furthermore, commentary, such as a note, a tag, or a relational annotation provided by a user, can then be associated with the anchor and can be used to provide additional information about all or part of the document.

In some cases, an anchor and any associated commentary can be grouped with other anchors to form a Quote Bundle. A Quote Bundle can be an organization tool that can facilitate the research and writing process by grouping related information and commentary about that information in a single unit. Furthermore, an anchor can be inserted in a user created document. In some cases, when the anchor is inserted in a user created document, any available citation information for that anchor can also be automatically inserted in a proper citation format.

To facilitate the accumulation of a body of legal knowledge, the anchor and any associated commentary can be saved to a server where users of the Legal Knowledge system can later gain access to it. In some cases, the Legal Knowledge system can be configured such that one or more users can be granted access to an anchor, commentary, and/or Quote Bundle. One way in which a user can discover legal knowledge within the Legal Knowledge system, including anchors, commentary, and bundles, can be through the built-in search feature in the Legal Knowledge system.

In some embodiments, a user can select a quotation from a document or from the set of previously identified quotations. Based on the selected quotation, information related to the quotation can be displayed in a manner that reflects a relationship between the quotation and the related information. For example, the related information can include documents that reference the selected quotation and/or documents that the quotation references. A representation of these documents can be displayed as well as their relationship. Additional relationships can also be displayed, such as overrules, questions, supports, similar subject matter, etc. In some configurations, the related information can include user created documents.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates exemplary client-side configurations for interacting with the Legal Knowledge system;

FIG. 3 illustrates features of the Legal Knowledge system;

FIG. 4 illustrates an exemplary method for processing a document;

FIG. 5 illustrates an exemplary decomposition of a document into its component parts;

FIG. 6 illustrates an exemplary UI window for updating a user profile;

FIG. 7 illustrates an exemplary UI window for creating a user generated access group;

FIG. 8 illustrates an exemplary communications configuration that is regulated by the asset manager;

FIG. 9 illustrates an exemplary UI window for browsing legal documents;

FIG. 10 illustrates an exemplary UI window for keyword type search;

FIG. 11 illustrates an exemplary UI window for advanced search in which the user can limit the search scope;

FIG. 12 illustrates another exemplary UI window for browsing legal documents;

FIG. 13 illustrates an exemplary method of displaying the citation frequency in the search results;

FIG. 14 illustrates an exemplary document tree;

FIG. 15 illustrates another exemplary document tree;

FIG. 16 illustrates exemplary methods of selecting text from documents;

FIG. 17 illustrates an exemplary method of adding a quotation to a Quote Bundle;

FIG. 18 illustrates an exemplary method of organizing quotations into Quote Bundles;

FIG. 19 illustrates exemplary quotation and Quote Bundle annotations;

FIG. 20 illustrates an exemplary document composition configuration;

FIG. 21 illustrates injecting a quotation using a plug-in;

FIG. 22 illustrates an exemplary method embodiment for conducting legal research and writing;

FIG. 23 illustrates an exemplary method embodiment for conducting legal research;

FIG. 24 illustrates an exemplary method embodiment for organizing legal research;

FIG. 25 illustrates an exemplary method embodiment for conducting legal writing;

FIG. 26 illustrates an exemplary method embodiment for writing a contract; and

FIG. 27 illustrates an example system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. The present disclosure addresses the need in the art for improved methods of selecting targeted content presented to a user based on characteristics descriptive of the user and/or the user's interaction with one or more items of targeted content.

### 1. Ecosystem Overview

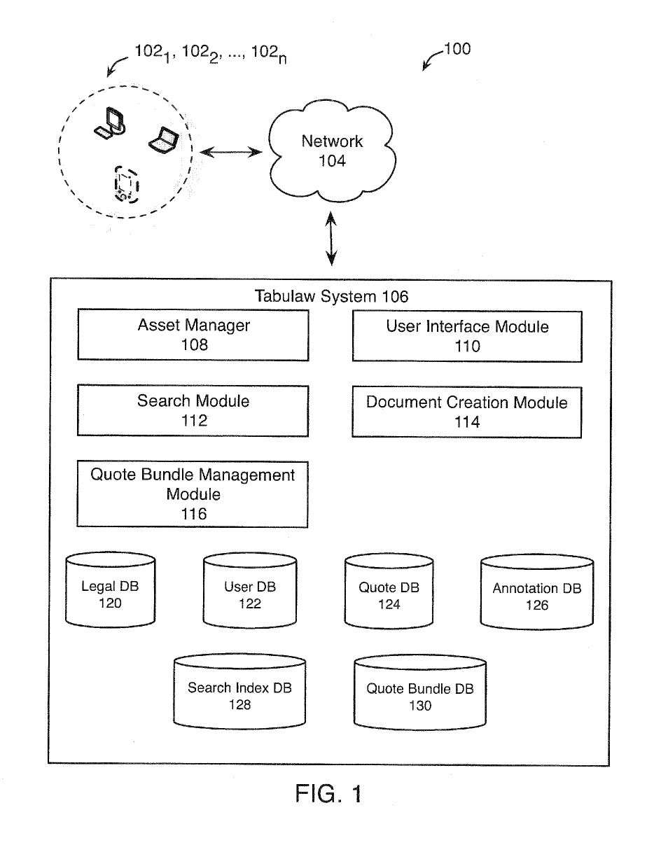

The presently disclosed system and method is particularly useful for conducting legal research and writing tasks in a manner that facilitates efficiency, collaboration, and unification of tasks. An exemplary ecosystem configuration 100 is illustrated in FIG. 1 wherein users can interact with the Legal Knowledge system 106 via a network 104 for purposes of conducting legal research and writing tasks. The system can be configured for use on a local area network such as that illustrated in FIG. 1. However, the present principles are applicable to a wide variety of network configurations that facilitate the intercommunication of electronic devices. For example, each of the components of ecosystem 100 in FIG. 1 can be implemented in a localized or distributed fashion in a network.

In ecosystem 100, a user interacts with the Legal Knowledge system 106 through user terminals 102₁ . . . 102ₙ (collectively “102”) connected to a network 104 by direct and/or indirect communication. The Legal Knowledge system 106 can support connections from a variety of different user terminals, such as desktop computers; mobile computers; handheld communications devices, e.g., mobile phones, smart phones, tablets; and/or any other network-enabled computing devices. Furthermore, the Legal Knowledge system 106 can concurrently accept connections from and interact with multiple user terminals 102.

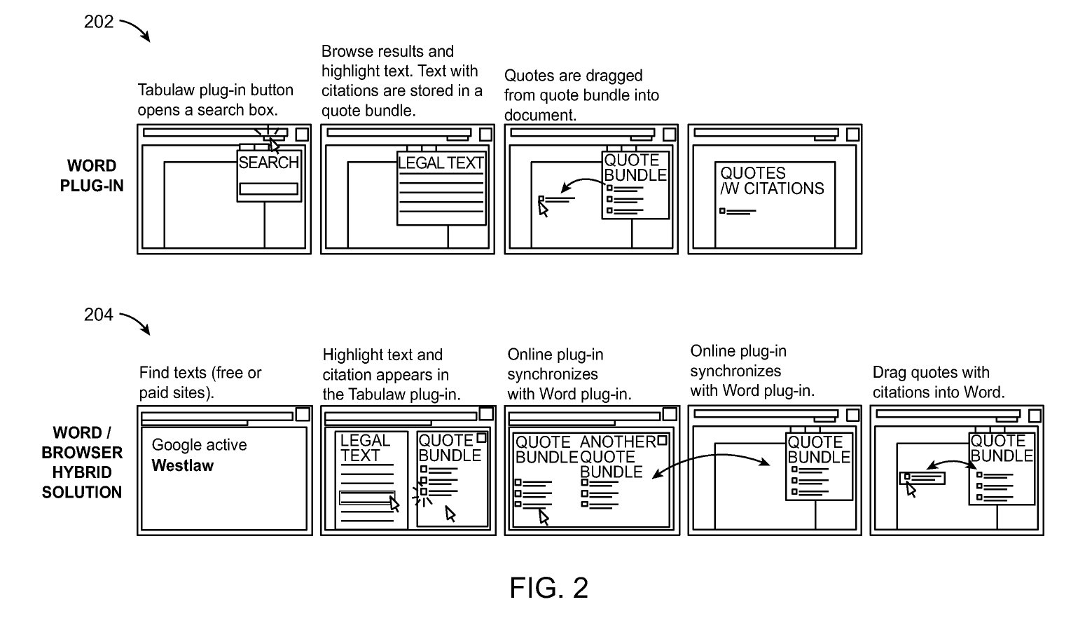

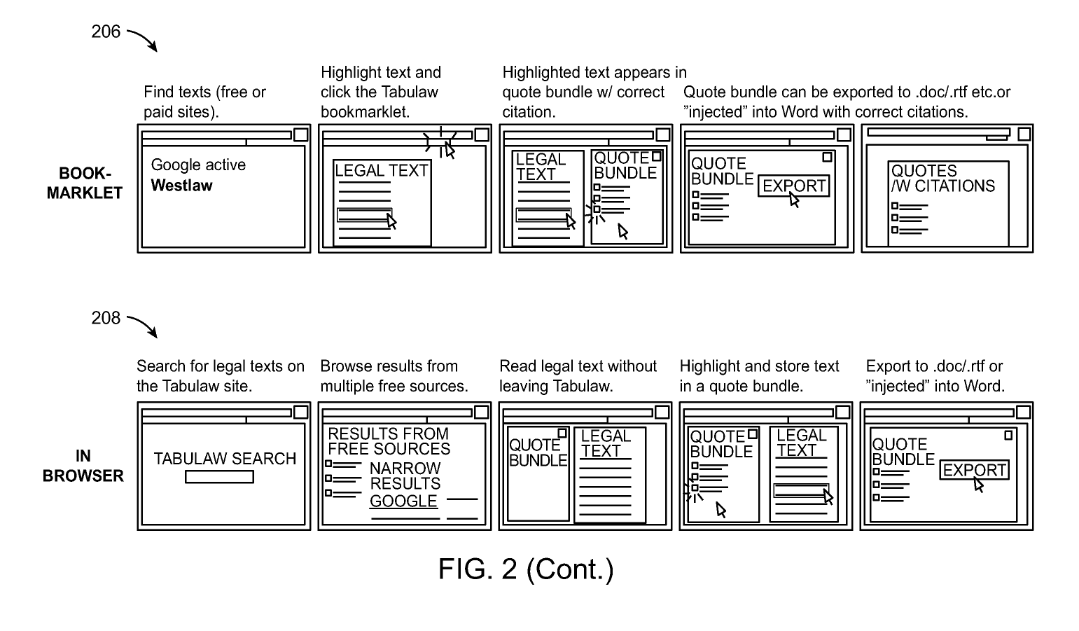

A user can interact with the Legal Knowledge system 106 via a client-side application installed on the user terminal 102. In some embodiments, the client-side application can include a Legal Knowledge specific component. For example, the component could be a stand-alone application, one or more application plug-ins, and/or a browser extension. However, the user can also interact with the Legal Knowledge system 106 via a third-party application, such as a web browser, that resides on the user terminal 102 and is configured to communicate with the Legal Knowledge system 106. In either case, the client-side application can display a user interface (UI) for the user to interact with the Legal Knowledge system 106. FIG. 2 illustrates a number of possible client-side configurations for interacting with the Legal Knowledge system 106. For example, the user could interact with the Legal Knowledge system 106 via a word processing application plug-in 202, via a combination of word processing application and web browser application plug-ins 204, 206, or via a webpage displayed using a web browser application 208.

### 2. Legal Knowledge System

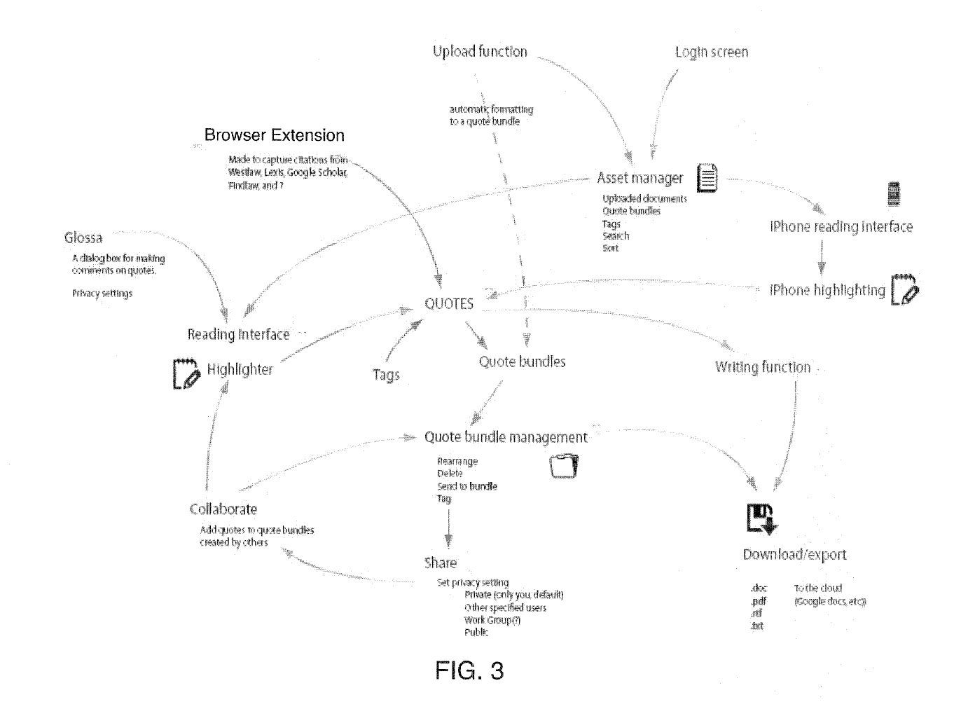

The Legal Knowledge system 106 makes it possible for a user to interact with a number of assets maintained by the Legal Knowledge system 106 as well as perform a number of tasks useful in the legal research and writing process. The assets and tasks will be discussed in greater detail in the subsections below; however, FIG. 3 provides a general overview of a subset of the functionality provided by the Legal Knowledge system 106.

As illustrated in FIG. 3, there are many different ways a user can interact with the Legal Knowledge system 106. For example, the Legal Knowledge system 106 can contain a database of legal documents, which can be managed by an Asset manager. The database can be automatically populated based upon available primary sources of law or a user can upload documents. The Legal Knowledge system 106 can provide one or more reading interfaces for reading documents in the Legal Knowledge databases and highlighting/selecting quotes from the documents. Alternatively, the user can use a Legal Knowledge browser extension to capture quotations from web-based documents. After the user selects one or more quotes, the user can create a Quote Bundle. A user can then add tags or comments to the quotes and/or Quote Bundles. Through Quote Bundle management, users can share and collaborate on Quote Bundles. Finally, a user can use the quotes to aid in legal writing. The Legal Knowledge system 106 features and usage scenarios are discussed in more detail in the following sections.

The exemplary Legal Knowledge system 106 is described with a focus on legal research and writing tasks. It should be understood to one skilled in the art that such a restriction is not necessary. The Legal Knowledge system 106 can be configured to maintain databases of reference material and to support citation formats other than those used within legal research and writing. For example, the Legal Knowledge system 106 can be configured with primary and/or secondary sources from multiple disciplines, e.g., law, economics, and sociology, or from a single discipline, e.g., computer science. Then any researcher interested in conducting research and writing tasks in the supported discipline(s) can use the Legal Knowledge system 106.

### 2.1 Architecture

As illustrated in FIG. 1, the architecture of the Legal Knowledge system 106 can contain a number of components. The components can include one or more databases for storing data relevant to the operation of the system, e.g., a legal database 120, a quote database 124, an annotation database 126, a search index database 128, and a Quote Bundle database 130, and one or more modules for interacting with the databases and/or controlling the features provided by the system, e.g., an asset manager 108, a user interface module 110, a search module 112, a document creation module 114, and a Quote Bundle Management module 116. Each of the components in FIG. 1 is discussed in more detail below; however, it should be understood to one skilled in the art, that the architectural configuration illustrated in FIG. 1 is simply one possible configuration and that other configurations with more or less components is also possible.

### 2.1.1 Databases

The Legal Knowledge system 106 can maintain a number of assets, such as one or more databases of information. In the exemplary configuration illustrated in FIG. 1, the Legal Knowledge system 106 maintains six databases. However, it should be understood to one skilled in the art that the Legal Knowledge system 106 can be configured with more or less databases.

Legal database 120 can be comprised of primary legal sources, e.g., statutes, regulations, case law, and secondary legal sources, e.g., law review articles. The legal database 120 can be populated with documents in a number of ways. In one example, the documents can be obtained from a third party database. Examples of third party databases include publicly available databases of legal sources from the government (e.g., uscode.house.gov), academia (e.g., law.cornell.edu), or other sources or private databases like WESTLAW that users can access with a license. In another example, the Legal Knowledge system 106 can also crawl the web to identify documents to add to the legal database 120. This technique can be particularly useful in obtaining secondary sources like law review articles. Additionally, users can upload documents to the Legal Knowledge system 106. In some configurations, user contributed documents may be reviewed prior to being added to the legal database 120.

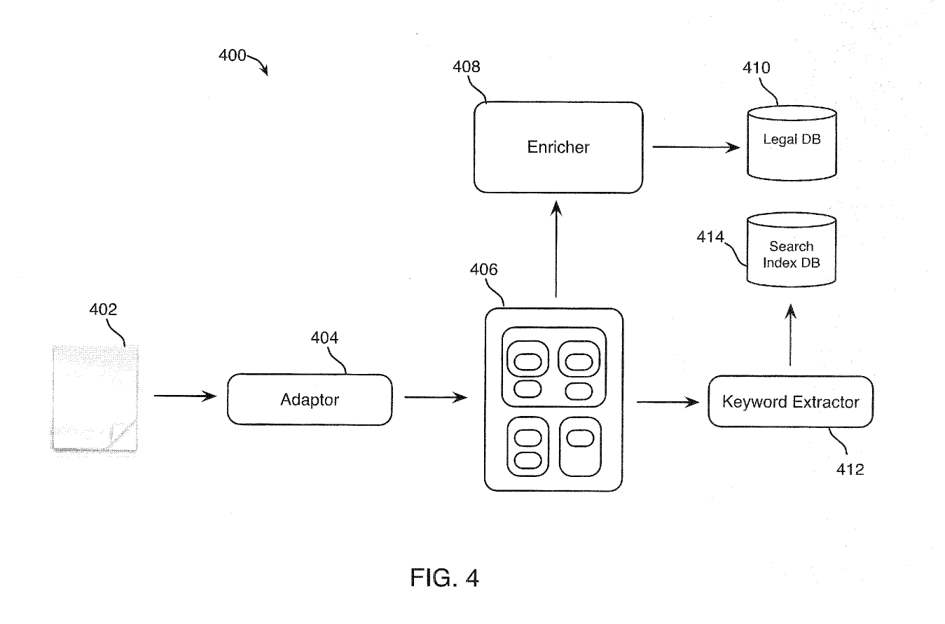

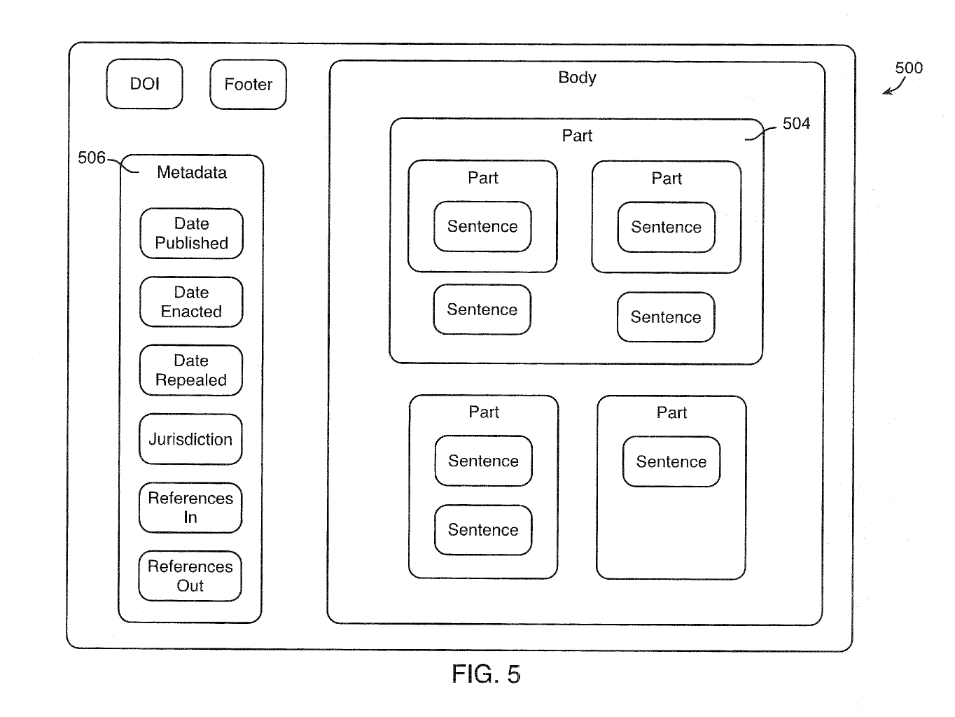

Prior to adding a document to the legal database 120, the Legal Knowledge system 106 can process the document. FIG. 4 illustrates an exemplary method 400 for processing a document. First, document 402 is passed to adaptor 404. The adaptor 404 formats document 402 into a standardized format using XML or some other web compatible format. During the standardization process, the adaptor 404 can decompose the document into its component parts as illustrated with document 500 in FIG. 5. The document 500 contains body, part, sentence, and footer components. Furthermore, the components can be nested, as illustrated by part 504. Other components are also possible, such as chapter, section, sub-section, paragraph, etc.

The standardized document 406 is then passed to enricher 408, which augments the document with metadata and/or a Document Object Identifier (DOI). For example, metadata 506 illustrates possible data that can be added to enrich the document. After enriching, the document can be added to the legal database 410.

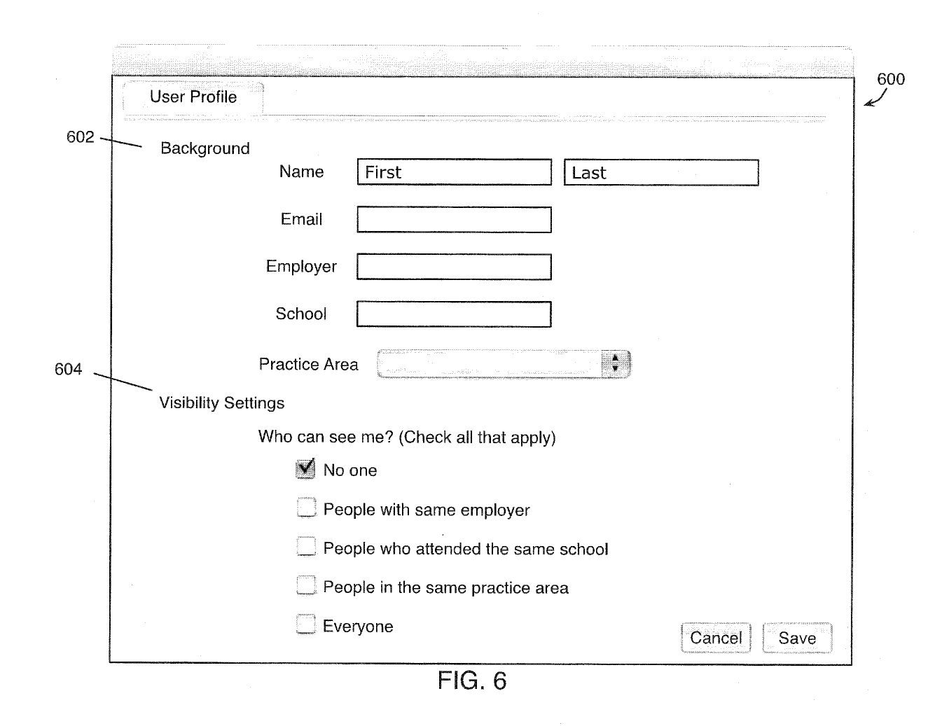

The Legal Knowledge system 106 can also maintain a user database 122. The user database 122 can store profile information for the registered users. In some cases, the only personal information in the user profile is a username and/or email address. However, the Legal Knowledge system 106 can also be configured to accept additional user information, such as background information and visibility preferences. FIG. 6 illustrates an exemplary UI window 600 for updating a user profile. In this example, the user profile includes some background information 602, i.e., name, email address, employer, school, and practice area. The user can also specify their visibility preferences 604.

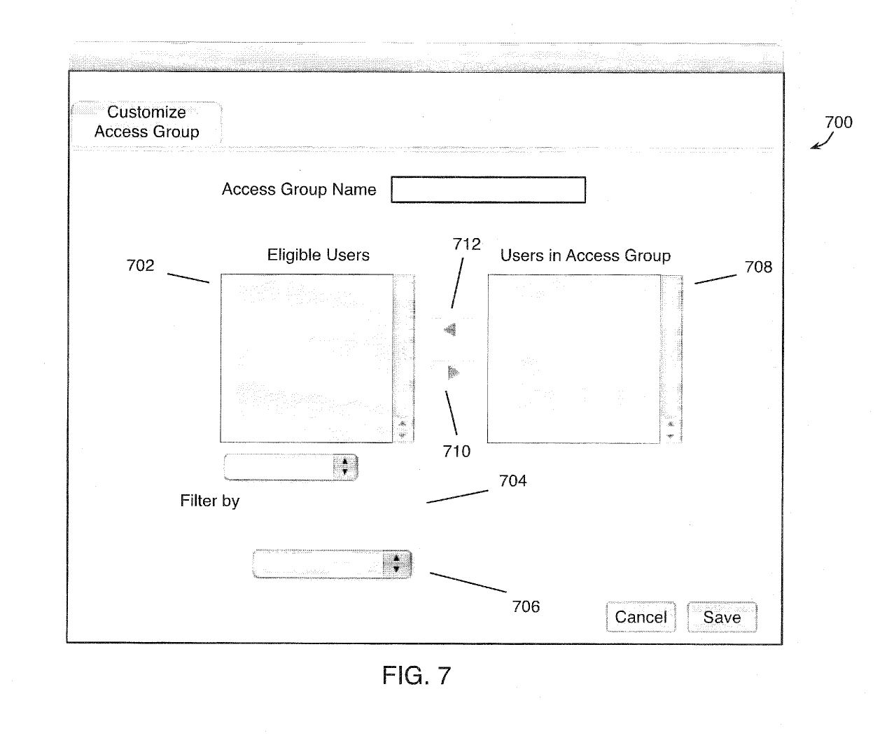

In some cases, the personal information in the user profile can be used to customize the user experience. For example, the background information can be used to automatically assign a user to one or more access groups. That is, the Legal Knowledge system 106 can automatically create an access group for each employer, school, and practice group known to the system. When a user provides their background information, the Legal Knowledge system 106 can automatically assign the user to the appropriate access groups. Furthermore, the background and visibility information can be used in a user created access group feature. An exemplary UI window 700 for creating a user generated access group is illustrated in FIG. 7. This feature can allow a user to define an access group and the users in the group. Whether a user is included in the pool of eligible users can depend on the user's visibility settings. For example, if a user A's visibility setting is “no one,” then user A will not appear in the pool of eligible users and user B who is creating an access group will not be able to add the user to the group. However, if user A's visibility setting allows for users with the same employer to see him or her, then user A can be added to a group by a co-worker user. The user profile information can also be used to filter the users that appear in the eligible pool. For example, a user creating an access group can select one of the background categories from the drop down box 704, e.g., employer. Based on the selection, drop down box 706 can be populated with all values known for the selected background category, e.g., a particular employer. The users displayed in the eligible users window 702 will then be narrowed based on the filter selections. The user can then select individual users from the eligible users window 702 and add them to the users in access group window 708 using button 710. A user can also remove a user from the access group using button 712.

In some configurations, the user profile can contain information related to the research and writing tasks performed by the user. For example, the Legal Knowledge system 106 could maintain the user's search and/or document reading histories. Maintaining different types of histories can be advantageous for the user. For example, suppose the user is in the middle of researching a particular topic and gets interrupted. The stored history can help the user pick up where he or she left off. The history information can also be helpful if a user realizes at a later date that he or she needs to re-explore the results of some research previously conducted. The stored history can help the user return to that research without having to repeat the research.

The length of time the stored history is maintained can depend on the configuration of the system. For example, the history can be stored for 24 hours, one week, one month, etc. Alternatively, the amount of history maintained can be based on quantity, e.g., number of searches conducted or documents read. For example, the last 5 searches or last 10 documents read could be stored. In some configurations, both length of time and quantity can be used to determine what history is maintained. For example, the Legal Knowledge system 106 can store the last 5 searches, but if a search is older than 1 month, then it is purged. The history storage parameters can be differently configured for each history type, e.g., search and documents read. Additionally, in some configurations, the user can set the history parameters and/or the user can select individual items in the history to purge.

The user profile can also include user created content, such as documents, quotes, annotations, and/or Quote Bundles. In some cases, the user profile will contain references to the user created content instead of the content directly. The references can point to one or more other databases, such as the quote database 124, annotation database 126, and/or Quote Bundle database 130.

One of the features of the Legal Knowledge system 106, which will be discussed in more detail below, is that the user is able to capture quotes and store them for later use. A quote can be any section of text extracted from a document in the legal database 120 or some other document accessible to the user where the extracted text can be imported to the Legal Knowledge system 106. A quote can be stored in the quote database 124.

A number of items associated with a quote can also be stored in the quote database 124. For example, to facilitate the automatic insertion of a citation when the quote is used in a user created document, the Legal Knowledge system 106 can also store the associated citation in the quote database 124. The manner in which the citation information is stored can vary with the configuration of the system. For example, the citation information can be stored as a reference to the document in another database or storage location, along with the specific page number(s) for the quote. Alternatively, the Legal Knowledge system 106 can store all information necessary to create a full citation for each quote in the quote database 124.

The Legal Knowledge system 106 can also store access rights or permission settings with a quote in the quote database 124. For example, a stored quote may be visible only to the user that collected it; a specific group of users, e.g., all users from a specific firm; or all users of the Legal Knowledge system 106. In some configurations, the user can set the access rights on a quote he or she has selected and stored in the quote database 124. In some cases, the permission settings can have a default value, such as the quote will be visible to all users unless changed by the user.

In the case where a quote is visible to other users of the Legal Knowledge system 106, the Legal Knowledge system 106 can maintain a count of and/or reference to all uses of the quote in user created documents. This information can be stored with the quote in the quote database 124. Additionally, the Legal Knowledge system 106 can maintain a record of whether the quote is used in a Quote Bundle or not.

In some cases, the Legal Knowledge system 106 can be configured so that users can annotate a quote. The annotation can include a variety of different information, such as definitions, notes, commentary, parenthetical statements, tags, and/or links. The Legal Knowledge system 106 can store an annotation in the annotation database 126 and store a reference to the annotation in the quote database 124.

As with a quote, the Legal Knowledge system 106 can also store access rights or permission settings with an annotation in the annotation database 126. For example, the annotation can be set with public, private, or group access rights. In some configurations, the user who added the annotation can have full control over setting the access rights so as to protect the user's work product. In some cases, a default value can be set, such as the annotation is only visible to the user who created the annotation.

In some configurations, the Legal Knowledge system 106 can have different classes of annotations. The different classes can have different default access rights and/or different types of access rights. For example, the Legal Knowledge system 106 can have note and tag annotation classes. The note class can have a default access right of private, but the user can adjust the setting. The tag class, on the other hand, can be configured so that all tags are always public and the user cannot adjust the access rights. Any number of access rights configurations are conceivable.

Another feature of the Legal Knowledge system 106 is the ability to create Quote Bundles from the quotes and annotations. The Quote Bundles can be stored in the Quote Bundle database 130. The actual information stored in the Quote Bundle database 130 can vary with the configuration. In some configurations, the Legal Knowledge system 106 can store references or links to the quotes and annotations selected for the Quote Bundle. Alternatively, the Legal Knowledge system 106 can directly store the quotations and/or annotations.

As with the quotes and annotations, the Legal Knowledge system 106 can store access rights or permission settings with the Quote Bundle in the Quote Bundle database 130. For example, a Quote Bundle can be set with public, private, or group access rights. In some configurations, the user who created the Quote Bundle can set and/or change the access rights. In some cases, a default value can be set, such as the Quote Bundle is visible to all users of the Legal Knowledge system 106. Alternatively, access rights on a Quote Bundle can make it visible to all users, but only the user who created the bundle can edit it.

The Legal Knowledge system 106 can also maintain a search index database 128 to aid in search performance. The search index database 128 can be populated with information extracted from the documents as they are processed and added to the legal database 120. For example, referring back to process 400 in FIG. 4, after a document has been standardized, the keyword extractor 412 can be applied to the standardized document 406. The extracted keywords can then be added to the search index database 414. Additionally, in some configurations, the search index database 128 can be populated with information from user created content, such as user created documents, quotes, annotations, and/or Quote Bundles.

In the various embodiments, the one or more databases described herein can be implemented using any type of data structures. Such data structures include, but are not limited to, data structures for relational databases, key/value stores, graph databases, hierarchical databases, and distributed or columnar stores. Accordingly, although the various embodiments described herein may refer to specific data structures, in other embodiments such data structures can be substituted for any other type of data structure.

### 2.1.2 Asset Manager

The Legal Knowledge system 106 includes a number of assets, such as the legal database 120, user database 122, quote database 124, annotation database 126, search index database 128, and Quote Bundle database 130. The Legal Knowledge system 106 can include an asset manager 108 to administer the assets including what goes into and out of the various databases. For example, as new lawsuits progress through the legal system new legal precedent is established in the form of judicial opinions. As the judicial opinions are published, they have to be added to the collection of legal documents contained in the legal database 120. As described with reference to FIG. 4, each document is processed prior to adding it to the legal database 120. The asset manager 108 can control this process. This also applies to other legal documents. As statutes and regulations are created or revised the asset manager can control the process of adding them to the legal database 120. In such configurations that permit users to upload legal documents to be added to the legal database 120, the asset manager 108 can include mechanisms to verify the documents so that the legal database 120 does not become corrupted or polluted with irrelevant documents.

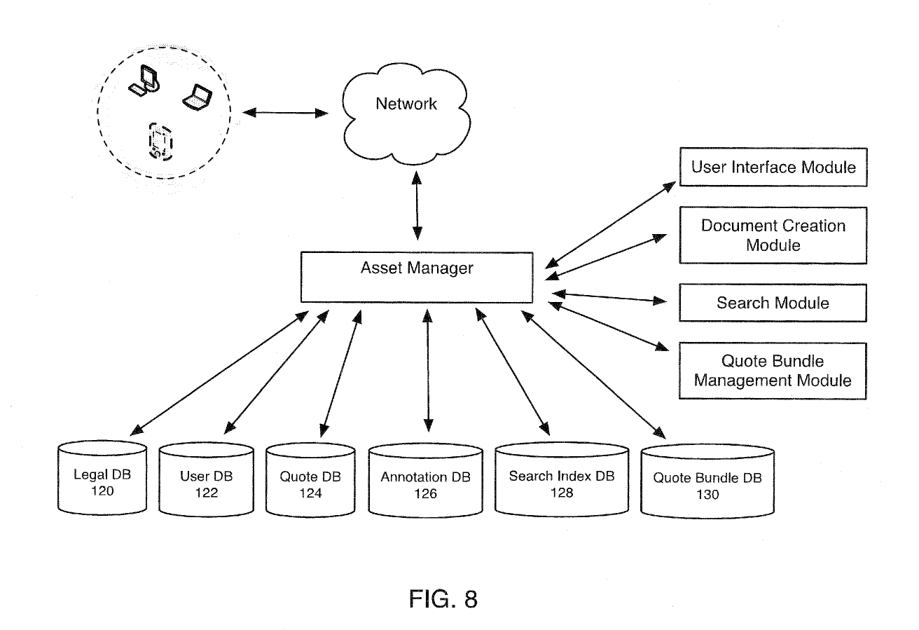

The asset manager 108 can also be configured to facilitate communication between the user terminals 102 and the various components within the Legal Knowledge system 106. For example, FIG. 8 illustrates a possible communications configuration. In this configuration, all communication goes through the asset manager. However, other configurations are also possible, such as configurations where a user can directly interact with one or more of the modules, where communication between the modules is possible, or where the modules interact directly with the databases.

### 2.1.3 User Interface

The Legal Knowledge system 106 provides a variety of functionality that requires user interaction, e.g., search, quotation selection, document creation, etc. Accordingly, a user interface (UI) can be provided for communicating with a user interface module 110 for performing such tasks. The UI for the user interface module 110 can be accessed via an end user terminal 102 in communication with the Legal Knowledge system 106. The UI and the user interface module 110 can be configured to operate in a variety of client modes, including a fat client mode, a thin client mode, or a hybrid client mode, depending on the storage and processing capabilities of the Legal Knowledge system 106 and/or the end user terminal. Therefore, a UI for the user interface module 110 can be implemented as a standalone application operating at the end user terminal in some embodiments. In other embodiments, a web browser-based portal can be used to provide the UI for the user interface module 110. Any other configuration to remotely or locally access the Legal Knowledge system 106 can also be used in the various embodiments.

The UI and user interface module 110 can be configured to provide users the ability to interact with the various tools and features provided by the Legal Knowledge system 106. In some cases, the user can customize the configuration of the UI. The UI customizations can be saved in the user database 122 and applied to the UI each time the user interacts with the Legal Knowledge system 106. Furthermore, the Legal Knowledge system 106 can present a different UI, different UI features, and/or different customization options for different types of user devices.

### 2.2 Features

The Legal Knowledge system 106 provides a user with a number of features to facilitate legal research and writing tasks. The primary feature categories offered by the Legal Knowledge system 106 can include research, quotation management, document creation, and collaboration. In some cases, a user may not be able to access all features from all types of user terminals. That is, the Legal Knowledge system 106 can be configured such that the features available to the user can be based on the capabilities of the user terminal. For example, a user interacting with the Legal Knowledge system 106 through a desktop computer may have access to all of the features. However, a user interacting with the Legal Knowledge system 106 through a handheld communications device may only be able to conduct searches, read documents, and select quotations from the documents.

The features accessible to the user can be additionally customized based on the connection type. For example, a user connected to the Legal Knowledge system 106 via a broadband connection may have access to all of the features, while a user connected through a cellular connection may only be able to conduct searches and read documents. In some cases, if the user switches from a cellular connection to a Wi-Fi connection while using the same device, the available features can increase. Conversely for a change from Wi-Fi to cellular—the available features can decrease.

### 2.2.1 Research

The primary research tasks performed by a legal researcher involve searching, filtering the search results, selecting relevant items from the search results, and organizing the selected search results. The Legal Knowledge system 106 can provide the legal researcher with tools to carry out these tasks. One of the tools offered by the Legal Knowledge system 106 to aid the legal researcher is a built-in search feature, which can be controlled by the search module 112. The user can interact with the search module 112 through the user interface module 110 to search the Legal Knowledge assets.

In some cases, a user can search the Legal Knowledge assets by browsing. For example, in some configurations, the legal documents can be placed into general categories based on the type of the legal document, such as statutes, regulations, and case law. These categories can then be further divided. For example, within the case law category there can be state and federal sub-categories. The state sub-category can then be further divided into categories based on the different states and the federal sub-category can be further divided into Supreme Court, appeals court, and district court categories. Further sub-division or different sub-divisions are also possible. The classification into browsing categories can be based on metadata, keywords, citations, and/or annotations associated with the documents.

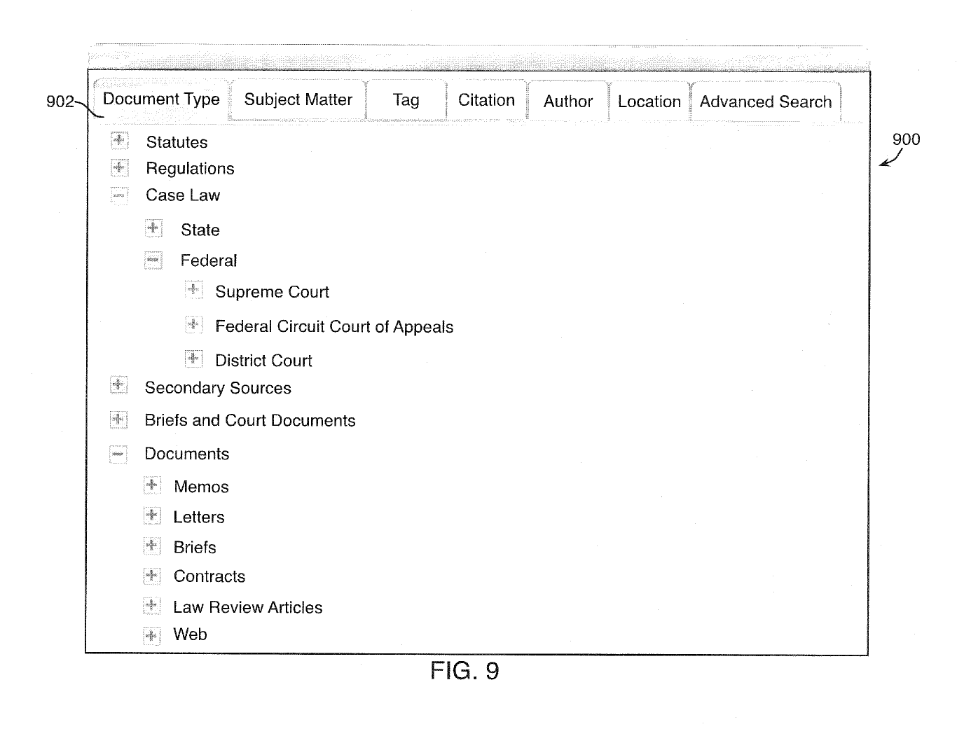

FIG. 9 illustrates an exemplary UI 900 for browsing legal documents in the Legal Knowledge system 106. In this figure, the browsing by Document Type tab 902 has been selected and the legal documents are classified using rather traditional legal classifications. The content displayed to the user can dynamically change as the user expands and collapses the categories. For example, when the user expands the Case Law category, the State and Federal sub-categories are displays. Alternative methods of displaying the possible categories, sub-categories, and legal documents are also possible.

As FIG. 9 indicates, other browsing classifications are also possible. For example, the Legal Knowledge system 106 can be configured so that a user can browse the legal documents based on subject matter, user created tags, citation, author, location (e.g., my docs, group, firm, web, etc.), location, and/or advanced search. Additional browsing classifications are also possible.

Once the browsing display has reached the legal document level, a variety of methods can be used to determine the order in which the documents are displayed. For example, the documents could be sorted based on some criteria, such as citation, or the documents could be ranked using a ranking mechanism, such as the ones discussed below. In some cases, there may be a natural order to display the documents. For example, with statutes and regulations it may be natural to display them based on the statute or regulation number. In some cases, the user can customize the method used to order and/or display the documents. The browse customization can be a one-time customization or it can be saved in the user's profile in the user database 122 to use each time the user conducts research by browsing the legal documents in the Legal Knowledge system 106.

In some cases, a user can search the Legal Knowledge system assets by performing keyword type searches. To perform a keyword search the search module 112 can directly search the Legal Knowledge assets, such as the legal database 120, using the search terms entered by the user. Alternatively, to improve the speed at which the Legal Knowledge system 106 returns the search results, the search module 112 can leverage the search index database 128. The search module 112 can include the usual capabilities of modern search technology, such as auto-complete and constructing queries using Boolean operators.

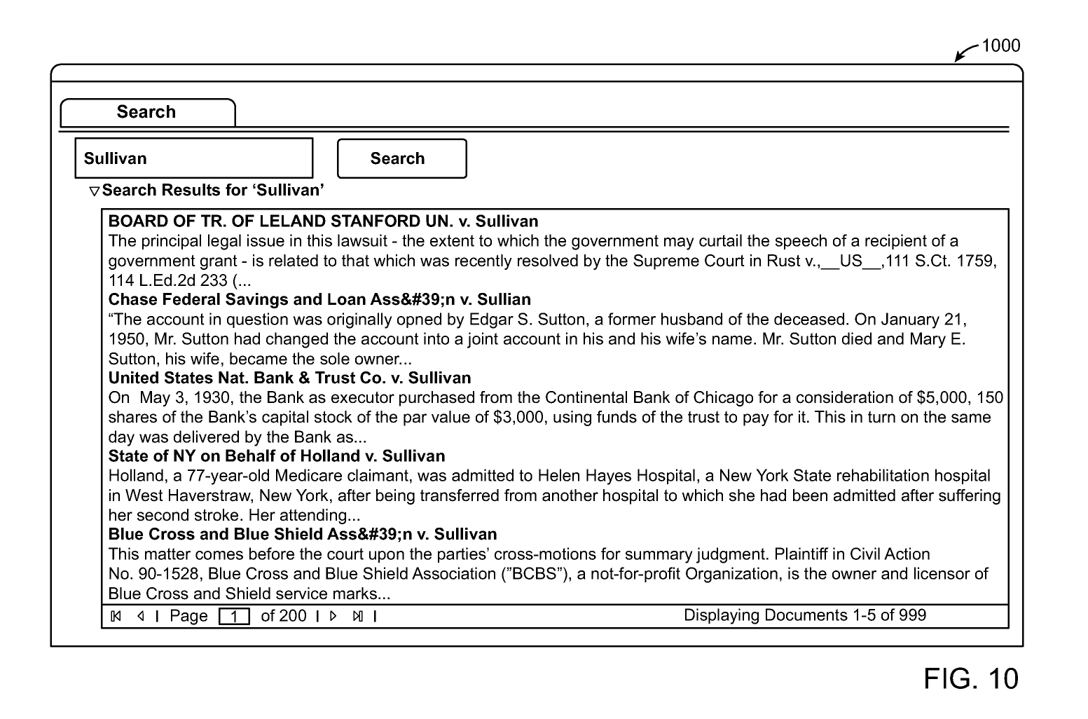

FIG. 10 illustrates an exemplary UI window 1000 for conducting keyword searches. In this example, the user enters one or more search terms in the search box and the results are displayed in a list fashion that the user can examine. The manner in which the search results are displayed as well as the number of results displayed at any given time can vary with the configuration of the system. In some cases, as illustrated in FIG. 10, the results can be displayed with a title and a preview or snippet of the document. Whether or not a preview is provided and/or what is included in the preview can vary with the configuration of the system. For example, the preview can be the first few lines of the document or the preview can be a heavily quoted section of the document. Additionally, the Legal Knowledge system 106 can be configured to allow the user to customize the document preview. As with other user customizations in the Legal Knowledge system 106, the preview customization can be a one-time customization or can be saved to the user profile in the user database 122 for use in displaying search results to the user.

The search module 112 can also make suggestions for narrowing the search or for conducting additional searches. For example, the Legal Knowledge system 106 can make a suggestion based on searches performed by other users. If other users have conducted a search with the same terms and then those users followed that search with another search, the Legal Knowledge system 106 could suggest the follow-on search to the user as an additional search. Alternatively, the Legal Knowledge system 106 can suggest a search based on other users who have also viewed the same set of documents that the user has recently viewed. Additional searches terms can also be suggested based on associations between the search term and other terms known to the Legal Knowledge system 106 or other search terms associated with one or more recently viewed documents. Other methods of suggesting additional search terms are also possible.

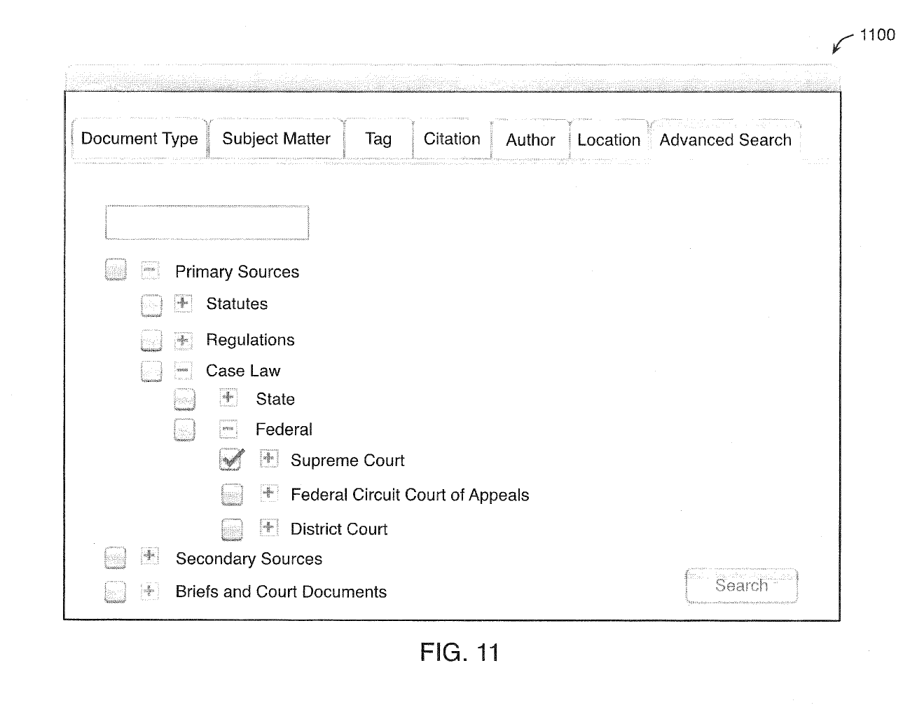

In some cases, the Legal Knowledge system 106 can provide methods so that the user can limit the search scope. For example, the user may want to limit the search results to primary source documents, statutes, Supreme Court cases, etc. The Legal Knowledge system 106 can provide such functionality through an advanced search option, such as that illustrated in UI window 1100 in FIG. 11. In this example, the user can expand and collapse different categories and then select one or more categories in which to limit the search scope. Other methods of allowing the user to limit the search scope are also possible.

In some cases, the user's search history can be stored in the user profile in the user database 122. This can allow the user to pick up on an interrupted search or retrace research steps. For example, if a user conducts a search, examines some of the documents in the search results, and then continues down another exploration path, there may come a point when the user has exhausted the chosen path. At that point, the user may wish to return to the original search. By storing the search results, the user can return to the original search without having to repeat previous work. Additionally, the user can use the stored history to evaluate what research he or she has already conducted and from that formulate a plan for additional research. Furthermore, the user can share their stored search history with other users, such as co-workers. This may be particularly useful if multiple users are working together on a project. In some cases, the Legal Knowledge system 106 can facilitate search history sharing through the assignment of access rights to the search history. In this case, the user can assign access rights based on which other users should have access. For example, the user can create a group containing those users who he or she is working with and grant access to that group.

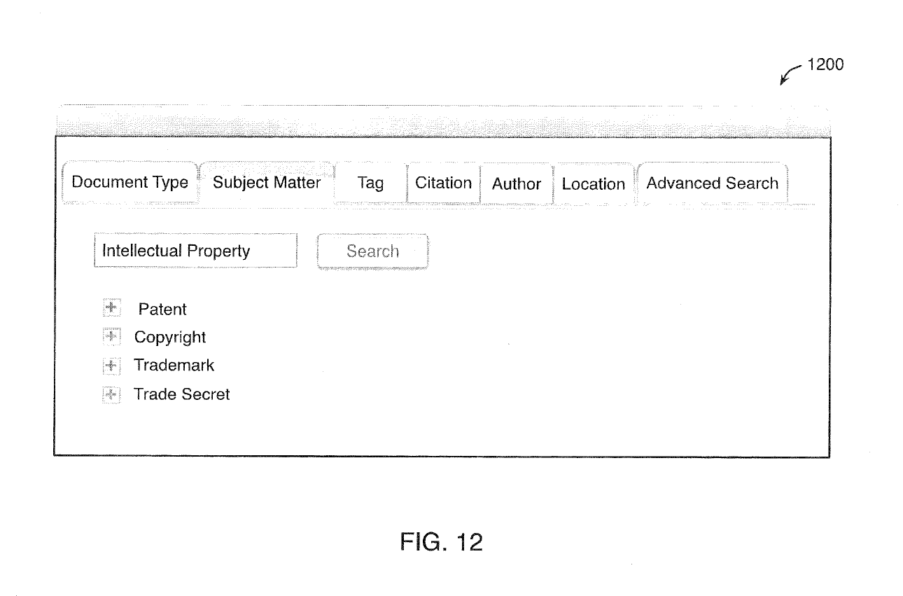

In some cases, the browsing feature can be coupled with a search feature to enable more focused browsing. An exemplary UI 1200 for coupling browsing and search is illustrated in FIG. 12. In this example, the user has entered the search term “Intellectual Property.” Based on this search, the Legal Knowledge system 106 has limited the documents eligible for display based on the four traditional types of intellectual property law: patent, copyright, trademark, and trade secret. These categories can then be expanded to display sub-categories, which can be based on subject matter or some other classification such as document type. At some point, the user will reach a display level in which links to or the actual legal documents are displayed. In some cases, the search term may be so specialized that instead of displaying browsing categories, the Legal Knowledge system 106 will display a list of the relevant documents. In this case, the browsing feature can behave in a manner associated with the more traditional search feature discussed above.

One advantage of the Legal Knowledge system 106 is that when a user conducts a search, the search is not limited to the text of the documents in the legal database 120. Instead, the user created content, such as the annotations in the annotations database 126 or the user created documents, can be included in and/or influence the search results. For example, Tags can be one of the annotation types in the Legal Knowledge system 106. The Legal Knowledge system 106 can include a standard set of Tags as well as user created. The Tags can provide context to improve the search results. For example, a document or a portion of the document can be tagged with the terms “novelty” and “patent.” When a user conducts a search for the novelty standard related to patents, the tagged document can be included in the search results. In some cases, a document may not be included in the search results without the extra information provided by the annotations.

A unique aspect of the built-in search feature is that, in some configurations, the Legal Knowledge system 106 can provide the ability to search and browse the assets at various levels of granularity. For example, in addition to document level searching or browsing, a user can choose to search or browse at the Quote Bundle, quotation, annotation or even phrase level. As a result, references to a ‘document’ in this application (e.g. ‘document ranking’) can be substituted for an asset at any of these levels of granularity. Other levels of granularity are also possible. In some cases, the results from a granular search can be expanded to show the context or containing document. For example, with a quotation-level search, the search results can display the paragraph(s), page(s), or precise character range in which the quotation appears.

In some cases, the Legal Knowledge system 106 can use machine learning algorithms or other learning algorithms and the user created content to learn more about the documents in the legal database 120. In other cases, the Legal Knowledge system 106 can use the user created content to obtain additional keywords to associate with the documents in the legal database 120. The user created content can also be used to re-enforce the keywords already known about a document. For example, suppose during the processing step discussed in FIG. 4, the keyword “novelty” was associated with the document. At some later point, one or more users annotate the document with the term “novelty.” Based on the user created content, the Legal Knowledge system 106 can develop a greater degree of confidence with respect to the keyword “novelty.” This confidence can be used in determining whether or not to include the document in the search results and/or the ranking of the document within the search results. A document with a higher confidence level with respect to the search term can be ranked higher in the search results.

Additionally, users can vote on annotations. In some configurations, the voting can be binary. For example, a user can cast a positive or negative vote. A positive vote can indicate that the annotation accurately describes the document or the portion of the document to which the annotation is attached. A negative vote can indicate the annotation is not entirely accurate. In some cases, if an annotation receives a certain number of negative votes, the Legal Knowledge system 106 can remove the annotation. The number of negative votes required to trigger the removal can vary with the configuration of the Legal Knowledge system 106. In some configurations, if an annotation has a negative vote it can have a lesser influence on the search results and/or the ranking of the documents within the results. Other methods of voting on annotations are also possible.

The degree of influence can vary with the configuration of the Legal Knowledge system 106, the type of annotation, the status of the user, other user characteristics, etc. For example, an annotation added by a user classified as a student may have a lesser influence than an annotation added by a licensed attorney. Alternatively, an annotation added by an attorney whose practice area coincides with the subject matter of the legal document, may have a greater influence on the search results than an annotation added by an attorney in an unrelated practice area.

In addition to influencing the body of documents contained in the search results, the annotations can influence the ranking of the documents within the search results. For example, a document that has a greater number of relevant annotations associated with it may have a higher ranking. Alternatively, the Legal Knowledge system 106 can be configured such that documents with relevant annotations created by the user are assigned a higher ranking than documents with annotations by other users. In some cases, the user can set the degree of influence the annotations have on the search results. For example, the user may indicate that all relevant annotations should be considered equally or that the user's own annotations should have a greater influence on the results. Alternatively, the user could indicate that the annotations should be considered in shaping the body of the search results, but should not be further considered in ranking the documents within the search results. The degree of influence customization can be a one-time customization. However, in some configurations, the customization preference can be saved in the user's profile in the user database 122 and used each time the user conducts a search. Other methods of incorporating the annotations in the document rankings are also possible.

Document ranking can be an important aspect of displaying search results to users since the order in which the documents are displayed can increase or decrease the amount of manual filtering required by the user. Ideally, the documents should be displayed such that those of greatest interest to the user are displayed at the top of the list. In establishing a ranking, the Legal Knowledge system 106 can consider a number of factors in addition to or as an alternative to the annotation influenced rankings discussed above.

A factor the Legal Knowledge system 106 can consider in ranking the search results is one or more dates associated with the document. The dates associated with the document can include the publication date, the last date in which a user associated an annotation with the document, the last date a user selected a quote from the document, and/or the last date in which a user cited the document in a user created document. Each of these dates can be an indication of the relevance of a particular document.

Another factor the Legal Knowledge system 106 can consider in ranking the search results is the citation frequency of the document. A document that has greater legal significance is likely to be cited in user created content more frequently than documents with little legal significance.

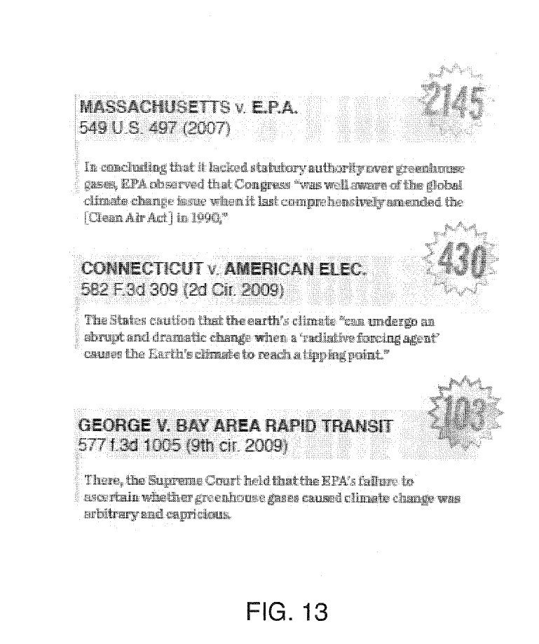

The Legal Knowledge system 106 can also display the citation frequency in the search results. The display of such information can allow the user to incorporate the information when he or she decides which documents to further investigate. FIG. 13 illustrates an exemplary method of displaying the citation frequency in the search results. In this example, those documents with a higher citation frequency are ranked higher in the search results. The citation frequency can be the general citation frequency for the legal document or the Legal Knowledge system 106 can consider the citation frequency of the quotations cited in user created documents relevant to the current search term(s). For example, users may cite a single document due to its discussion of the summary judgment standard as well as its discussion of personal jurisdiction. If the user has conducted a search related to summary judgment, then the Legal Knowledge system 106 can consider the citation frequency of the summary judgment related quotations from the legal document.

In some cases, the Legal Knowledge system 106 can consider the precedential value of the document in determining the ranking One way the Legal Knowledge system 106 can consider the precedential value is to rank legal opinions from higher-ranking courts higher in the list. For example, a legal opinion from the Supreme Court would be ranked higher than one from a district court. Alternatively, the Legal Knowledge system 106 can consider whether the legal document has any negative treatment. For example, if a subsequent legal opinion has overruled a prior opinion, the document could be ranked lower in the results. In some cases, the information necessary to determine the precedential value can be found in the metadata of the document, the citation, and/or annotations created by the users. For example, one set of standard Tags the Legal Knowledge system 106 can include are relational tags, such as overrules, limits the scope of, expands the scope of, adopts, etc. Users can add these Tags to create relationships between documents and indicate the precedential value of the document or a portion of the document.

Another factor the Legal Knowledge system 106 can consider in ranking the search results is information learned from past search histories. In some cases, if one or more users have previously conducted searches with the same or equivalent search terms, the Legal Knowledge system 106 can rank the search results based on the documents viewed by those previous users. For example, if multiple users all conducted searches using the same search terms and all viewed the same set of documents, the Legal Knowledge system 106 can rank those viewed documents higher in the search results on subsequent searches based on the assumption that they have a higher degree of relevance. The past search history considered by the Legal Knowledge system can vary with the configuration of the system. In some cases, the Legal Knowledge system 106 can consider the past search history of all users, a subset of the users, and/or the user conducting the current search. Furthermore, the Legal Knowledge system 106 can use machine learning and/or predictive algorithms to learn which documents have a higher degree of relevance from the search histories and/or the other user created content.

In some cases, the user can customize the information used to determine a ranking of the documents. For example, the user could indicate that citation ranking, precedential value, and date of publication should be used to rank the documents. In some cases, the user customization can be a one-time customization. Alternatively, the customization can be saved to the user profile and applied to subsequent searches conducted by the user.

The Legal Knowledge system 106 can also rank results associated with granular level searches, such as quotation-level searches. In this case, the same techniques used for document ranking can be used to rank the granular level search results.

In some cases, the user can conduct a search and then choose to sort the search results. The user could sort the results based on a factor, examine the results, and then choose to sort the results based on a different factor. For example, the user could first sort the results by precedential value, examine the results, and then re-sort the results by citation frequency. Furthermore, the user can select multiple values for sorting, such as date of publication and precedential value. This feature can aid the legal researcher manually filter the results.

As discussed above, the Legal Knowledge system 106 can consider user created content in determining whether a document is likely to be of interest to a user. Furthermore, by considering user created content, additional context is available outside of the static keywords associated with the documents. This allows for the search results to change as the body of law changes and the legal community's understanding of that body of law evolves, or even as a single user's understanding of the law evolves. As a result, the search results will have a higher degree of relevance and will require less manual filtering by the user, which improves the efficiency of the legal researcher.

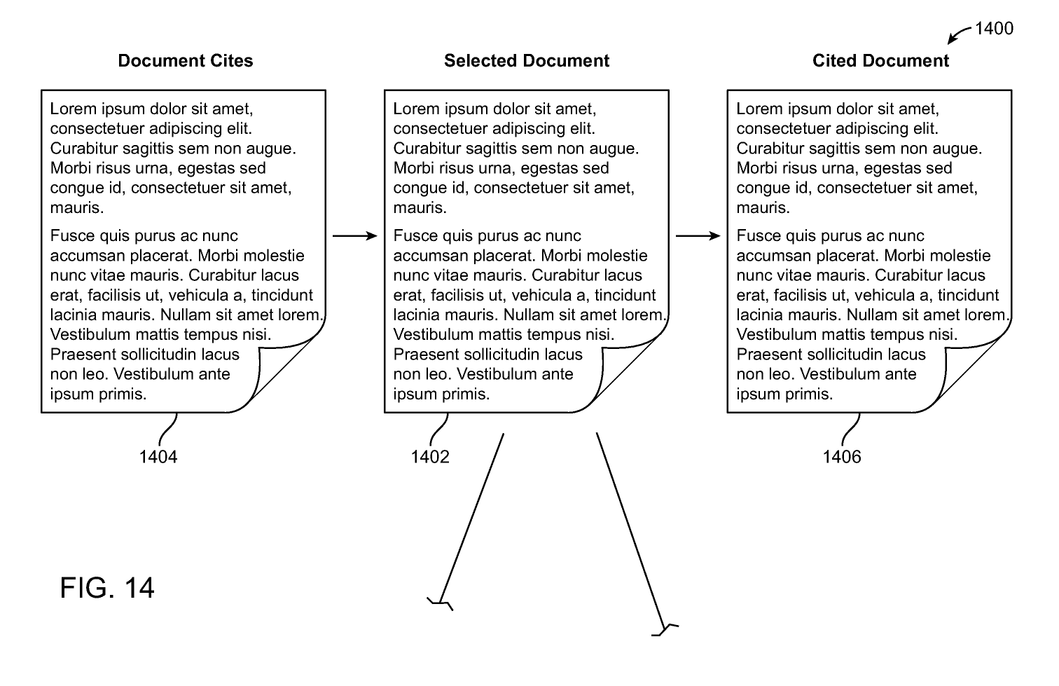

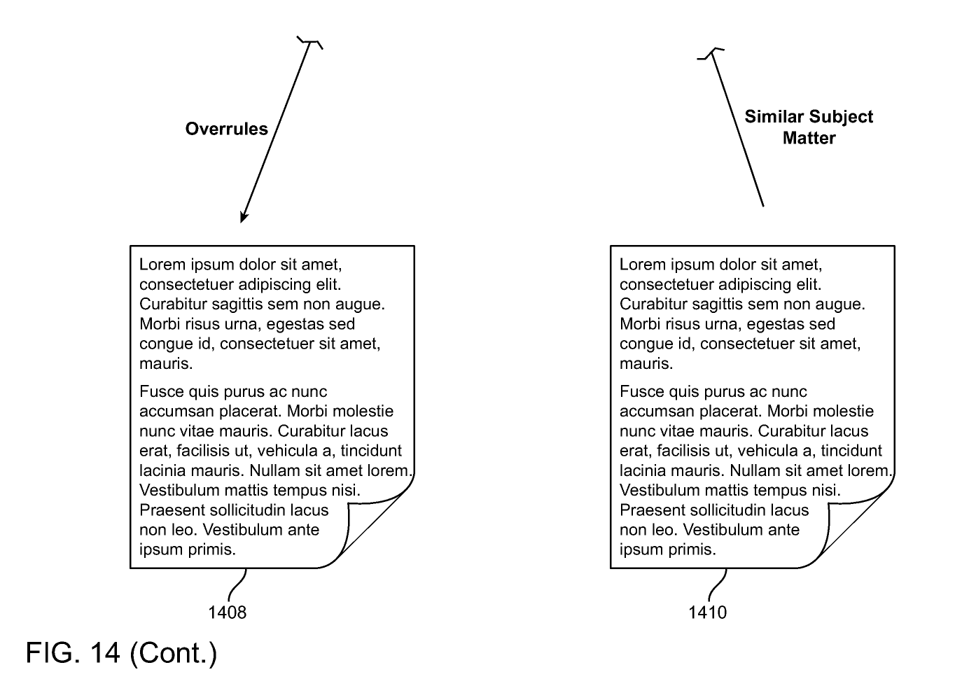

In addition to browsing the documents or performing more traditional keyword type searches, a user can conduct research within the Legal Knowledge system 106 by starting with a particular legal document, such as a seminal case. Even without user created content, by starting with a document in the legal database 120, a user can discover other relevant material. For example, as part of the document processing illustrated in FIG. 4, the Legal Knowledge system 106 can identify other documents that are cited by the document. From this information, the Legal Knowledge system 106 can begin to build a document tree similar to the document tree 1400 illustrated in FIG. 14. In the document tree 1400, the selected document 1402, the documents 1404 that cite it, and the documents 1406 that it cites can be initially displayed to the user. As users create content, such as annotations and user created documents, the document tree can become more specialized. For example, through users adding one or more standard relational Tags discussed above, specialized relationships between the documents can be displayed, e.g., the selected document 1402 overrules document 1408. Furthermore, through the user created annotations additional related documents can be added to the tree, for example, because they discuss one or more similar topics, e.g., selected document 1402 and document 1410 contain similar subject matter. Document tree 1400 also illustrates that, in some configurations, the connectors used in the display of the document tree can indicate relationships between the documents. For example, the directional arrow between documents 1402 and 1408 indicates that document 1402 overrules document 1408.

In some cases, the document tree can display the user created documents in which the selected document is cited. The Legal Knowledge system 106 can be configured such that access rights regulate which user-created documents are displayed. For example, only user created documents created by the user that have a public access setting, and/or a group access setting to which the user belongs, can be displayed. Alternatively, the Legal Knowledge system 106 can be configured so that only documents created by the user are included in the document tree.

The Legal Knowledge system 106 can also display other user created content associated with the selected document in the document tree. For example, any comments attached to the document can be displayed. As with the user created documents, the Legal Knowledge system 106 can be configured to respect any access rights associated with the user created content when selecting the items to display in the document tree.

In some cases, the user can customize what relationships are displayed in the tree. For example, a user may not be interested in which documents the selected document cites or the documents that it overrules. As another example, a user may only be interested in seeing the associated user-created documents that he or she created or that were created by a user in a group to which he or she belongs. Furthermore, in some cases, the user can specify which groups from which to display user created documents. As yet another example, a user may not be interested in viewing Comment type annotations created by other users. As with other user customizations in the Legal Knowledge system 106, the customization can be a one-time customization or it can be saved to the user's profile in the user database 122 for use each time the user conducts research using a document tree. The one-time customization can be used to dynamically change the document tree so that the user can explore different research avenues.

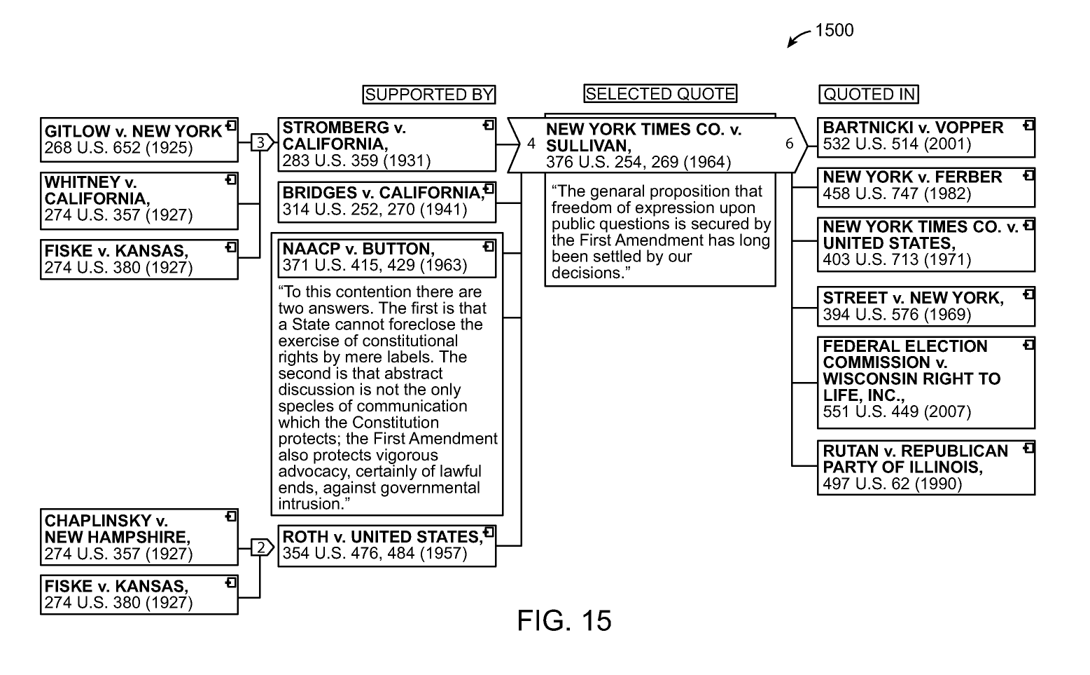

As noted above, a user can work at many levels of granularity. Therefore, in addition to viewing a document tree based on a whole document, the Legal Knowledge system 106 can be configured so that a user can selected a particular aspect of a document, e.g., a particular subject matter, page, quote, etc. Based on the selected aspect, the displayed document tree can dynamically change. For example, FIG. 15 illustrates an exemplary document tree 1500 based on a single quote in a document.

As part of the browsing/searching process, the user is able to select documents to view and read. For each of the searching methods discussed, i.e., browsing, keyword search, hybrid search-browse, and document tree browsing, the Legal Knowledge system 106 can provide one or more UI configurations from which the user can select one or more documents. In some cases, the Legal Knowledge system 106 can maintain a history of the documents the user has selected to view and/or read. The number of documents in the history as well as the length of time the history is maintained can vary with the configuration with the Legal Knowledge system 106 and/or user preferences. In some configurations, the user can group selected documents into categories for future reference. The Quotation Management section below provides a more detailed description of the various tools provided by the Legal Knowledge system 106 for organizing the research results.

### 2.2.2 Quotation Management

A common task performed by a legal researcher after identifying a relevant legal document is to select one or more quotations from the document. These quotations are often selected with the idea that they will be used in some form or another, such as a direct quotation or paraphrase, in a legal document written by the legal researcher. The main challenge associated with this task is not really in selecting the quotations, although that can be a challenge, but is actually in maintaining the quotations, along with reference information and other relevant metadata, so that they are accessible and usable when they are needed. The Legal Knowledge system 106 provides a number of tools to aid the legal researcher in selecting, organizing, and maintaining quotations.

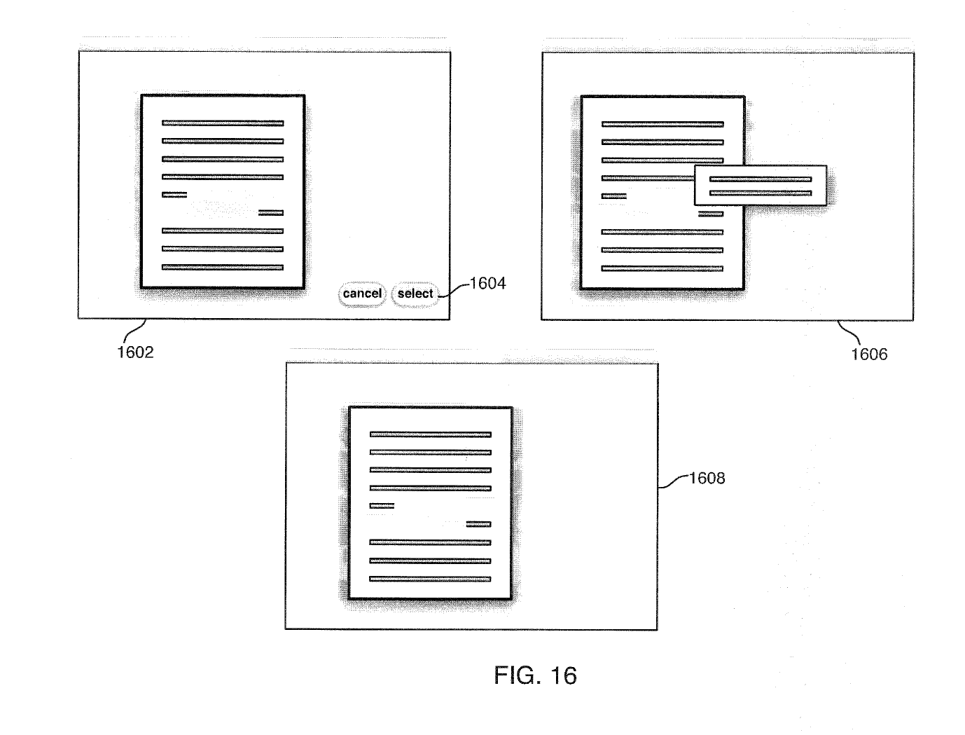

An important feature of the Legal Knowledge system 106 is the ability to select segments of text, or quotations, from one or more documents, while maintaining reference information and other relevant metadata. In some configurations, the Legal Knowledge system 106 can provide tools for selecting text from documents contained in the Legal Knowledge system 106, such as documents in the legal database 120. The Legal Knowledge system 106 can provide a variety of different methods for selecting text. For example, FIG. 16 illustrates 3 possible methods of selecting text from documents in the Legal Knowledge system 106. Exemplary UI window 1602 illustrates a method of selecting text by highlighting the desired section of text, for example, by clicking a mouse button and dragging the mouse across the desired text and releasing the mouse button, and then clicking the select button 1604 to make the final selection. Exemplary UI window 1606 illustrates a method of selecting text by highlighting the desired section and then dragging the section from the document. Exemplary UI window 1608 illustrates a method of selecting text by highlighting the desired section of text and then when the user completes the highlighting motion, for example, by releasing a mouse button, the Legal Knowledge system 106 automatically collects the highlighted selection. Other methods of selecting text are also possible, such as designating begin and end points or by selecting pre-determined text units, e.g., sentence or paragraph.

In some cases, the method of selecting text can vary with the type of device and/or the capabilities of the device. For example, the Legal Knowledge system 106 can be configured such that a user connected via a desktop or laptop computer can highlight a section of text by way of an input device like a mouse or trackpad, and then the user drags the selected text to a designated portion of the screen. However, if the user connects to the Legal Knowledge system 106 via a handheld communications device, which often have small screen and/or limited input capabilities, the user can highlight by designating start and end points. Once the user has designated both points, the Legal Knowledge system 106 can automatically capture the highlight section as a quotation.

In some cases, the user can select multiple sections of text from a single document without requiring selection actions from the user. For example, in the selection method illustrated in UI window 1602, the user can highlight multiple sections of the document and then click the select button 1604. Likewise, with the selection method illustrated in UI window 1606, the user can highlight a selection of the text and perform an action such as holding down a key on the keyboard, highlight one or more sections of additional text, and then drag the sections simultaneously. With this action the Legal Knowledge system 106 can create multiple quotations.

In some cases, the user can select multiple sections of text and combine them into a single quote. This can be advantageous when selecting a contiguous section of the text, such as sentence or multiple sentences, contains superfluous information. For example, a single sentence may be long and only the beginning and end are necessary to convey the point. In this case, the user can select the desired sections and then perform an action, such as clicking a button, to indicate that the selections should be combined. The Legal Knowledge system 106 can create a single quote in which the selected text is combined using ellipses.

In some configurations, the Legal Knowledge system 106 can recommend quotations to the user. The manner in which the Legal Knowledge system 106 recommends quotations can vary with the configuration of the system. In some cases, when a user opens a document for viewing within the Legal Knowledge system 106, the document can contain pre-highlighted sections. Whether a particular section is selected for pre-highlighting can be based on the document's relationship with other documents in the Legal Knowledge system 106. For example, a section can be selected for pre-highlighting because it is cited in another document in the legal database 120. In some cases, a section can be selected for pre-highlighting because the user or other others previously highlighted it. A section of text can also be selected for pre-highlighting because it is a well known quote. Other methods of selecting text to suggest to the user are also possible, such as a hybrid approach based on citation in a document in the legal database 120 as well as use by other users.

As with the user-highlighted text, the manner in which the user can select a pre-highlighted section can vary with the configuration of the system and/or the user device. For example, the Legal Knowledge system 106 can be configured such that the user simply clicks on or hovers over any portion of the highlighted text to select the suggested text as a quotation. Alternatively, the Legal Knowledge system 106 can be configured so that the user drags the highlighted section off the document or towards a designation portion of the screen. Other methods of accepting a suggested quotation are also possible.

Additionally, the Legal Knowledge system 106 can suggest quotations based on the text the user is currently selecting. For example, the Legal Knowledge system 106 can suggest an end for the quotation at the end of the sentence from which the user is currently selecting text. Alternatively, the Legal Knowledge system 106 can suggest an end for the quotation based on usage of the selected text in other documents in the Legal Knowledge system 106, such as quotations in other legal documents in the legal database 120 or quotations selected by other users. Such suggestions can be particularly useful on user devices with limited input capabilities, e.g., handheld communications devices.

In some cases, the user can customize the pre-highlighting. For example, a user may not be interested in suggestions from the Legal Knowledge system 106, so the user can turn off the suggestions. Alternatively, the user may not be interested in quotations used by other users. The customization can be a one-time customization, such as a suggestion filter applied to the viewing of the current document, and/or the customization can be stored in the user profile in the user database 122 and applied anytime the user views a document in the Legal Knowledge system 106.

In addition to collecting and maintaining the quotations, a legal researcher is also tasked with devising a system for ensuring that each selected quotation has a proper citation. For some legal researchers this may involve devising a quote collection scheme in which the researcher selects the quote, copies it to a word processing document and then adds the proper citation information to the quote. However, in some cases, the legal researcher often simply makes note of the quote and enough information to identify the source in the future. This approach can require the legal researcher to once again find the document and quotation to determine the full citation. To address the burden and inefficiencies associated with maintaining the proper citation information, the Legal Knowledge system 106 can automatically associate the complete citation information with the selected quotation. Automatically associating the proper citation with the selected quotation can be facilitated by the standardized document format used in the Legal Knowledge system 106. Since each document is processed and standardized prior to its addition to the legal database 120, the Legal Knowledge system can identify the document information as well as the specific page(s) associated with the quotation.

In some configurations, the Legal Knowledge system 106 can also provide tools for importing text selected from documents outside of the Legal Knowledge system 106. Importing can occur through client-side applications, like browser plug-ins, or by uploading the selected quotation to the Legal Knowledge system 106. In some cases, the Legal Knowledge system can automatically determine the citation information for the quotation. For example, if the quotation is imported using a browser plug-in, the plug-in may be able to determine the citation information from the webpage through metadata or other information on the page. In this case, the Legal Knowledge system 106 can automatically import the citation information. Alternatively, the Legal Knowledge system 106 may be able to match the quotation with documents contained in one or more databases in the Legal Knowledge system 106 to determine the citation information. However, in some cases, the Legal Knowledge system 106 may not be able to automatically determine the citation information for imported text. In this case, the Legal Knowledge system 106 can prompt the user to provide the information. In some configurations, even if the Legal Knowledge system 106 can automatically determine the citation information for the imported text, the system can prompt the user to verify the citation.

In some configurations, the Legal Knowledge system 106 can automatically assign a selected quotation a name. For example, the Legal Knowledge system 106 can assign a name based on the citation or the first few words in the quotation. However, the Legal Knowledge system 106 can also be configured so that users can assign names to the quotations. This can allow the user to add a name that he or she finds more meaningful, aids in the organization, and/or quickly triggers understanding of the quotation and the reason for its selection in the future. In some configurations, only the user who selected the quotation can name the quotation. In other cases, the ability to name a quotation can be based on access rights. In some cases, multiple names can be associated with a single quotation.

Depending on the configuration, one or more of the assigned names can be displayed simultaneously. In some cases, the decision of which names to display can be based on access rights. For example, the Legal Knowledge system 106 can be configured such that only the name assigned by the user currently working with the quotation is displayed. Alternatively, if the user working with the quotation is part of a group, then, in some cases, all names assigned by members of that group can be displayed. The decision of which names to display can also be based on user customization preferences. For example, a user may only want to see the name he or she assigned to the quotation. In other cases, the user may want to see all names assigned to gain further insight or reach ideas.

The selected quotations, including the quotations obtained from documents outside of the Legal Knowledge system 106, can be stored in the quote database 124 and can be associated with the user. The Legal Knowledge system 106 can be configured such that a reference to the quotation in the quote database 124 is stored in the user profile in the user database 122. Additionally, in some configurations, access rights can be associated with the selected quotation. In some cases, the Legal Knowledge system 106 can automatically set the access rights, such as by assigning a default access right or by assigning access rights based on the user's profile. Additionally, in some configurations, the user can customize the access rights. For example, the user may grant access rights to all users in a particular access group defined by all users working on a particular case.

The legal researching task does not often culminate in the selection of a single quotation. Rather, the legal researcher explores a number of documents, selecting one or more quotations from multiple resources with the goal of later synthesizing the selected quotations to support a particular idea or state the standard of law for the situation. Furthermore, the legal researcher may need to repeat these steps multiple times to provide the necessary support for the numerous points or arguments that he or she must make in the document. This process can result in the collection of dozens of quotations.

To facilitate the organization of multiple related quotations, the Legal Knowledge system 106 can provide Quote Bundles. A Quote Bundle is a collection of one or more user-selected quotations that a user has grouped together. The formation of a Quote Bundle can vary with the configuration of the Legal Knowledge system 106. In some cases, the Legal Knowledge system 106 can be configured so that a new Quote Bundle can automatically be created when a user selects a quotation. The Legal Knowledge system 106 can also be configured so that the user takes a particular action while selecting the text, e.g., clicking a button or dragging the text to a section of the screen, to indicate that the selected text should be saved as a quotation and that it should also be the basis of a new Quote Bundle.

In some cases, a user can take an action separate from selecting text for a quotation to create a new Quote Bundle. For example, the Legal Knowledge system 106 can be configured such that the user clicks a “new Quote Bundle” button to initiate the creation of a new empty Quote Bundle. Alternatively, the Legal Knowledge system 106 can be configured such that the user selects one or more previously selected quotations and drags them to a designated portion of the screen or clicks a button to create a new Quote Bundle.

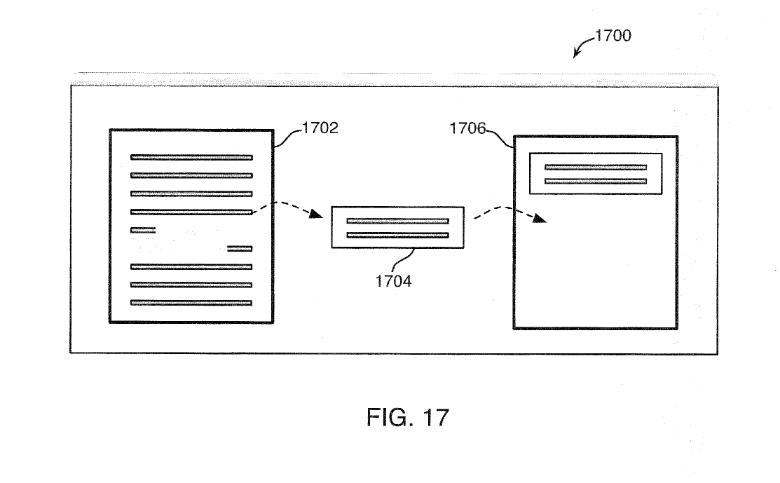

In some cases, a user can add one or more additional quotes to an already existing Quote Bundle. For example, as a user is selecting text for quotations, the user can add the newly selected quotation to an existing Quote Bundle. This method of adding quotations to Quote Bundles is illustrated in the exemplary UI window 1700 in FIG. 17. In this example, the user has opened document 1702 and Quote Bundle 1706. The user has highlighted a section in the document 1702. To create the quotation 1704 and add it to the Quote Bundle 1706, the user simply drags the selected text to the Quote Bundle 1706, which already contains another quotation.

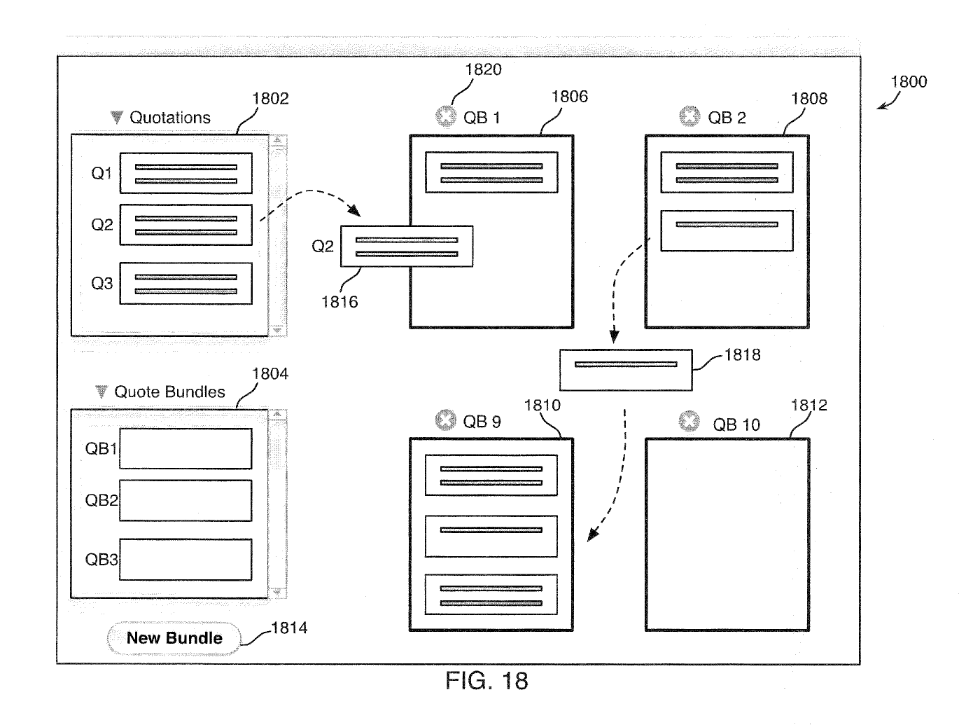

Alternatively, after a user has selected a number of quotations, the user can organize the quotations by adding them to one or more Quote Bundles. Exemplary UI window 1800 in FIG. 18 illustrates a possible method of organizing quotations into Quote Bundles. In UI window 1800 the quotations visible to the user are displayed in the Quotation scroll box 1802. Similarly, the previously created Quote Bundles accessible by the user are displayed in the Quote Bundle scroll box 1804. A user can select a Quote Bundle from the Quote Bundle box 1804 and the contents will be displayed in the window, e.g., Quote Bundles 1806, 1808, and 1810. A user can also click the “New Bundle” button 1814 to create a new empty Quote Bundle, e.g., Quote Bundle 1812. A user can then select quotations from the Quotation box 1802 to add to an open Quote Bundle. For example, quotation 1816 is added to Quote Bundle 1806 by dragging the quotation into the open Quote Bundle. Additionally, a user can move or copy a quotation from one Quote Bundle to another Quote Bundle. In the case of a copy action, the quotation can be included in both Quote Bundles. For example, quotation 1818 has been copied from Quote Bundle 1808 to Quote Bundle 1810. A user can also remove a quotation from a Quote Bundle. For example, the user could drag the quotation out of the Quote Bundle or select the quotation and click a delete button. Other methods of deleting quotations from Quote Bundles are also possible. Once a user has finished editing a Quote Bundle, the user can close the Quote Bundle though such methods as clicking a close button, e.g., button 1820, or deselecting the Quote Bundle from the list of Quote Bundles in Quote Bundle box 1804.

In some configurations, the user can customize various aspects related to the display of a Quote Bundle. For example, the user can specify whether the full quotation should be displayed, a snippet, or just the citation. As another example, the user can specify the order in which the quotations are displayed in the Quote Bundle, e.g., the order they were added, alphabetical, by year of the citation, etc. Additionally, the user can specify which quotations to display, e.g., quotations added by the user, quotations added by users in a particular group, quotations from statutes, quotations from secondary sources, etc. Other customizations are also possible. As with the various other customization options within the Legal Knowledge system 106, the Quote Bundle display customizations can be a one-time customization to provide a different prospective to the user. Additionally, the customizations can be saved to the user profile in the user database 122 and applied each time the user works with a Quote Bundle.

The Legal Knowledge system 106 can also be configured so that multiple users can contribute to a single Quote Bundle. This can be particularly useful with Quote Bundles for a commonly used legal standard, such as the standard for summary judgment, or when multiple legal researchers are working together on a project. The ability to read or edit a Quote Bundle can be regulated by access rights assigned to the Quote Bundle. In some cases, the Legal Knowledge system 106 can automatically set the access rights, such as by assigning a default access right or by assigning access rights based on the user's profile. Additionally, in some configurations, the user can customize the access rights. For example, the user may grant access rights to all users in a particular access group defined by all users working on a particular case. Furthermore, the access rights can specify read and write access. For example, a user may be willing to grant read access to all users of the Legal Knowledge system 106, but reserve the ability to edit the Quote Bundle to just himself or to a particular group of users.

In some configurations, the Legal Knowledge system 106 can automatically assign a Quote Bundle a name. For example, the Legal Knowledge system 106 can assign a name based on the first quotation added to the Quote Bundle. Alternatively, the Legal Knowledge system 106 can assign names sequential, such as Bundle1. However, the Legal Knowledge system 106 can also be configured so that users can assign names to the Quote Bundles. This can allow the user to add a name that he or she finds more meaningful, aids in the organization, and/or quickly triggers understanding of the collection of quotations. In some configurations, only the user who created the Quote Bundle can name the Quote Bundle. In other cases, the ability to name a Quote Bundle can be based on access rights. In some cases, multiple names can be associated with a single Quote Bundle. Additionally, a user can add a description to the Quote Bundle to add more meaning or provide additional information.

Depending on the configuration, one or more of the assigned names can be displayed simultaneously. In some cases, the decision of which names to display can be based on access rights. For example, the Legal Knowledge system 106 can be configured such that only the name assigned by the user currently using the Quote Bundle is displayed. Alternatively, if the user working with the Quote Bundle is part of a group, then, in some cases, all names assigned by members of that group can be displayed. The decision of which names to display can also be based on user customization preferences. For example, a user may only want to see the name he or she assigned to the Quote Bundle. In other cases, the user may want to see all names assigned to gain further insight or reach ideas.

The Quote Bundles can be stored in the Quote Bundle database 130 and can be associated with one or more users. The Legal Knowledge system 106 can be configured such that a reference to the Quote Bundle in the Quote Bundle database 130 is stored in the user profile in the user database 122.

In some configurations, after a Quote Bundle has been created, the Quote Bundle can be used to navigate a larger document. For example, a user can select a quotation in the Quote Bundle and the document from which the quotation originated can be displayed. The selected quotation, along with any quotations from the Quote Bundle can be highlighted. This feature can be used to identify relevant portions of a legal document that may contain a number of different topics.

In addition to collecting quotations and organizing them into groupings, a legal researcher often adds notes, commentary, or other associated information to the quotations and/or groupings during the researching process. The Legal Knowledge system 106 can provide similar functionality through the Annotation feature, which allows a user to attach one or more annotations to selected quotations and/or Quote Bundles.

The Legal Knowledge system 106 can be configured to support multiple types of annotations. Possible annotation types include, but are not limited to, definitions of words or phrases, notes/commentary, parenthetical statements, tags, and links. In some configurations, the Legal Knowledge system 106 can support different types of annotations for quotations versus Quote Bundles. For example, a user may not be able to add definitions or parenthetical statements to Quote Bundles, but such annotations can be attached to a quotation.

For certain types of annotations, the Legal Knowledge system 106 can include standard and custom versions of the annotation. For example, the Legal Knowledge system 106 can support standard and custom tags. Possible standard tags that a user can attach to a quotation or a Quote Bundle can include standard categories of law, e.g., patent, copyright, intellectual property, constitutional, 1st amendment, personal jurisdiction, summary judgment, etc. Standard tags can also be used to create relationships between a quotation or Quote Bundle and other quotations, Quote Bundles, and/or documents. For example, the Legal Knowledge system 106 can support the standard tags: overrules, limits the scope of, expands the scope of, adopts, etc. The relational tags can then include a reference or link to another quotation or document. Furthermore, the Legal Knowledge system 106 can include standard tags that describe a quotation's significance within a legal document, such as question presented, major holding, minor holding, rule, dissent holding, etc.

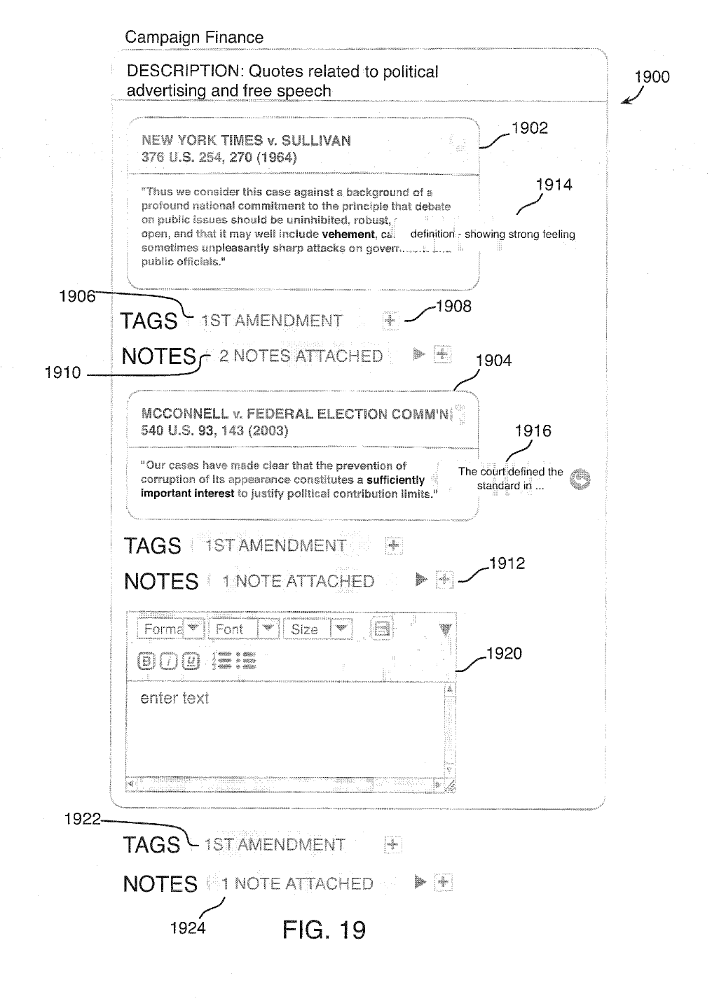

FIG. 19 illustrates an exemplary Quote Bundle 1900 and possible annotations that can be attached to the quotations in the Quote Bundle and to the Quote Bundle itself. Quote Bundle 1900 contains quotations 1902 and 1904. For each quotation in the Quote Bundle, the user can add tags and notes that pertain to the entire quotation. For example, quotation 1902 has a single tag 1906 indicating that the quotation pertains to the First Amendment. In this example, a user can add new tags by clicking the button 1908 and the user can remove a tag by dragging the desired tag out of the Quote Bundle. There are also two notes attached to quotation 1902, as indicated by description 1910. The description can be expanded to display the actual notes or further details about the notes from which the user can select in order to view a complete note. A user can add a new note to a quotation by clicking the addition button associated with that annotation. For example, the user can add a new note to quotation 1904 by clicking the button 1912. The Legal Knowledge system 106 can then display the note creation window 1920 where the user can add text, add links to other documents, save the note, close the note, minimize the note, etc.

A user can also add an annotation to a word or phrase in a quotation. The Legal Knowledge system 106 can support any number of different annotation types, such as editable, definition, relational, note, tag, etc. In this example, a user can add an annotation by highlighting a section of text. Once the user completes the highlighting action, the Legal Knowledge system 106 automatically creates an editable annotation. For example, the user has added the definition annotation 1914 to quotation 1902. Additionally, the user has added the relational annotation 1916 with commentary to quotation 1904. The relational annotation 1916 includes a link to another document in the Legal Knowledge system 106.

The user can also add annotations that are specific to the Quote Bundle. For example, Quote Bundle 1900 has both a tag, i.e., the 1st Amendment tag 1922, and a note, as indicated by note description 1924. Adding and deleting annotations associated with a Quote Bundle can be accomplished in a similar manner as with quotations.

As with many other features in the Legal Knowledge system 106, access rights can be assigned to the annotation. For example, the annotation can be set with public, private, or group access rights. In some configurations, the user who added the annotation can have full control over setting the access rights so as to protect the user's work product. In some cases, a default value can be set, such as the annotation is only visible to the user who created the annotation. Furthermore, the different types of annotations can have different default access rights and/or different types of access rights. For example, a note annotation can have a default access right of private, but the user can adjust the setting. A tag annotation, on the other hand, can be configured so that all tags are always public and the user cannot adjust the access rights. Any number of access rights configurations are conceivable.

Additionally, as with annotations attached to documents, users can vote on annotations. In some configurations, the voting can be binary. For example, a user can cast a positive or negative vote. A positive vote can indicate that the annotation accurately describes the item to which the annotation is attached. A negative vote can indicate the annotation is not entirely accurate. In some cases, if an annotation receives a certain number of negative votes, the Legal Knowledge system 106 can remove the annotation from public view. The number of negative votes required to trigger the removal can vary with the configuration of the Legal Knowledge system 106 and/or the type of annotation. For example, the Legal Knowledge system 106 can be configured such that a note can never be automatically removed despite the number of negative votes. Instead, a warning can be attached indicating negative user treatment. Conversely, a comment with a high positive vote can display a message indicating the positive treatment. As another example, if a tag, which is publicly visible, receives an adequate number of negative reviews, the Legal Knowledge system 106 can remove it. Other methods of voting on annotations are also possible, such as by recording a positive vote when an associated quotation is used in a user created document.

The Legal Knowledge system 106 can store an annotation in the annotation database 126. Depending on whether the annotation is attached to a quote or a Quote Bundle, the Legal Knowledge system 106 can store a reference to the annotation in the quote database 124 or the Quote Bundle database 130.

### 2.2.3 Document Creation

Often a legal researcher conducts various research tasks, such as those described above, in preparation for writing a document like a memo, brief, contract, etc. The Legal Knowledge system 106 can provide features that help integrate the research and quotation management features offered by the Legal Knowledge system 106 with the document creation task. In some configurations, integration can occur through a built-in word processing tool. The word processing tool can include the traditional features found in stand-alone word processing applications that allow a user to create and edit documents. The features can, but are not limited to, different types, sizes, and styles of font; undo; redo; select; cut; copy; paste; spell check; document formatting; etc.

The word processing tool can also include document templates specific to the common legal documents prepared by legal researchers. For example, the Legal Knowledge system 106 can include templates for memoranda, briefs, motions, and contracts. In the case of a template for a contract, the template can include boilerplate text for standard terms and sections. Furthermore, in some configurations, the Legal Knowledge system 106 can include templates specific to different jurisdictions. For example, some courts have specific formatting requirements, so the Legal Knowledge system 106 can include templates that adhere to those requirements. However, if the Legal Knowledge system 106 does not include a template that matches the specifications needed by the user, the user can create custom templates either from scratch or by editing an existing template. Additionally, the user can add the custom template to the library of templates for future use. In some cases, the user can make the template available to other users of the Legal Knowledge system 106.

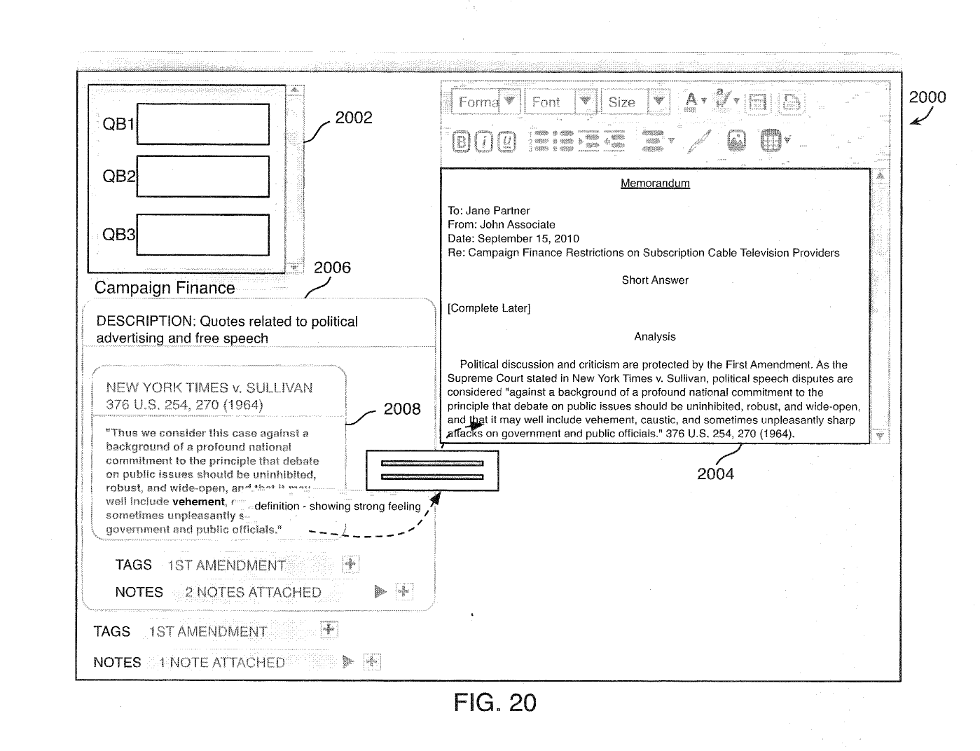

A key feature of the Legal Knowledge system 106 that facilitates integration of the research tasks with the writing tasks is the ability to use Quote Bundles in the document creation process. While composing a document a user can select to display one or more Quote Bundles along side the document composition window. For example, UI window 2000 in FIG. 20 illustrates an exemplary document composition configuration with the Legal Knowledge system 106. In this configuration the user can view the available Quote Bundles in the Quote Bundle box 2002 while composing a document in the document composition window 2004. A user can select one or more Quote Bundles from the Quote Bundle box 2002 to view. The selected Quote Bundles can also be displayed along side the document composition window 2004. For example, in the figure, the user has selected the Campaign Finance Quote Bundle 2006, which is displayed along the right side of the document composition window 2004. In addition to displaying the quotations contained in the Quote Bundle, the user can view all annotations attached to the quotations and/or Quote Bundle.

The Legal Knowledge system 106 can also support a user selecting all or part of a quotation from a Quote Bundle and dragging and dropping the selected text into the document composition window 2004. The drag and drop action can have the effect of copying and pasting the selected text into the user created document. Furthermore, because the citation information is associated with the quotation in the Quote Bundle, the Legal Knowledge system 106 can automatically insert the citation in the correct citation format, such as BlueBook, Chicago Style, MLA, etc. For example, in FIG. 20 the user has selected a portion of quotation 2008 and dropped it into the document in document composition window 2004. The document now includes the quotation, with quotation marks, and the proper citation. Furthermore, the Legal Knowledge system 106 can support pin citations commonly used in legal documents. For example, if the user has already inserted a citation to a document, the Legal Knowledge system 106 can detect the citation and the next citation to the document can be in pin cite format. Additionally, if the user inserts a new citation into a document prior to an original first citation, the Legal Knowledge system 106 can insert the full citation at the new location and update the subsequent citations. In some cases, the Legal Knowledge system 106 can also insert any parenthetical annotations attached to the quotation.

In some configurations, the Legal Knowledge system 106 can suggest quotations as the user composes a document. For example, the Legal Knowledge system 106 can detect that the user is planning to add a quotation when the user inserts a first quotation mark. The Legal Knowledge system 106 can then use the text entered after the quotation mark as search terms and suggest quotations based on the documents contained in the system. The suggestions can be displayed to the user who can select from the available suggestions. Once the user selects a quotation, the Legal Knowledge system 106 can insert the remaining text in the quotation in the document. A variety of different methods can be used to display the suggestions to the user. For example, the suggested quotations can appear in a box to the side of the document composition window 2004. Alternatively, the Legal Knowledge system 106 can display the suggestions in a box that hovers above the user's cursor. As the user continues to enter text, the Legal Knowledge system 106 can update the suggestion results. Along with the suggested quotations the Legal Knowledge system 106 can display the source of the quotation and/or additional context for the quotation. In some cases, the user can take an action, such as place their mouse over a suggestion, to see additional information about the quotation and/or open the source document. As with drag and drop quotations, the Legal Knowledge system 106 can automatically insert the proper citation for any quotation completed through a quotation suggestion.

In some configurations, the user can export the document from the Legal Knowledge system 106 so that it can be stored directly on the client device. The Legal Knowledge system 106 can support exporting to a number of different document formats, such as portable document format (PDF), Microsoft's WORD format, rich text format (RTF), plain text file, HTML, etc. In some cases, the available export formats can depend on the capabilities of the user device.

In some configurations, the user can customize various aspects of the word-processing tool. For example, in some cases, the user can customize the layout of the UI for document creation, such as by selecting to have the Quote Bundle displayed on the left of the document composition window. As was discussed in the Quotation Management section, the user can also customize the display of a Quote Bundle. The user can specify how much of a quotation is displayed in the bundle, the order of the quotations within the bundle, what quotations are displayed, what annotations are displayed, etc. In some cases, the user can specify whether parenthetical annotations attached to quotations should be automatically inserted when the quotation is inserted in the document. Additionally, in some cases, the user can specify a default export format. Other customizations are also possible. Any or all of the customizations can be one-time customizations or the customizations can be stored to the user profile in the user database 122.

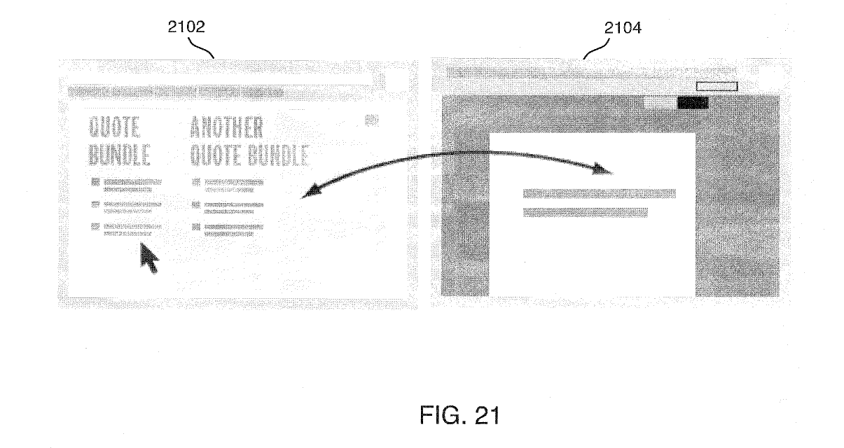

In addition to a built-in word processing tool, the Legal Knowledge system 106 can provide integration with a stand-alone word processing tool through an application plug-in. Through the plug-in the user can select quotations to inject into their document. For example, FIG. 21 illustrates injecting a quotation using a plug-in. In this example, the user can interact with the Legal Knowledge system 106 through the web browser 2102 while running the word processing application 2104 on their device.

Furthermore, the Legal Knowledge system 106 can provide an export feature for quotations so that a user can use their collected and organized research with other applications that do not support a client-side plug-in. A user can select one or more quotations, all quotations in one or more Quote Bundles, or one or more Quote Bundles to export to a file on the user's device. In some cases, the exported quotations can be formatted such that the exported file can be imported into another application. Alternatively, the exported information can be formatted to already include any necessary quotation marks and the proper citation information. A user can then copy and paste a quotation and the citation into the application they are using.

In some configurations, the Legal Knowledge system 106 can store a user created document in the user's profile in the user database 122. Alternatively, the Legal Knowledge system 106 can store the user created document in the legal database 120.

As with other user created content, the user created document can be assigned access rights. For example, the user created document can be set with public, private, or group access rights. In some configurations, the user who created the document can have full control over setting the access rights so as to protect the user's work product. In some cases, a default value can be set, such as the document is only visible to the user who created the document. In some configurations different default access rights can be set for different document types. For example, a memorandum or contract can have a default value of private, while a brief or motion can have a default value of public. The access rights can specify both read and edit permissions. For example, the user can specify that all users can view the document, but on the user can edit the document. In some configurations, the user can set access rights to indicate whether the document is searchable by the search module 112. Search based access rights can indicate whether the document can be included search results by the user or other users or whether uses of quotations in the document can be used in calculating quotation rankings. For example, the user can set access rights so that the document can be included in searches conducted by the user or by users within one or more specified groups. Other access rights configurations are also possible.

### 2.2.4 Collaboration

Outside of the realm of the solo practitioner, the tasks of legal research and writing are often conducted by a team of researchers all working on a single case. However, even the solo practitioner often collaborates with other legal researchers by drawing from and making contributions to the legal knowledge base through public legal documents like briefs and motions. The Legal Knowledge system 106 can enable collaboration between users who know that they are working on a common task, but also between all users of the system who happen to be conducting research and writing tasks similar to past and present users.

A drawback to the current legal knowledge base is that, even though users can contribute user created documents to the knowledge base, that knowledge base is distributed across many resources. A user is then forced to perform the unification task for him or herself or forego the benefits of drawing from the contributions of other members of the legal community. The Legal Knowledge system 106 can address this collaboration shortcoming by providing a unified repository of legal documents and user created documents. When a user conducts research, including searches, in the Legal Knowledge system 106, the research results can incorporate information from both the legal documents and the user created documents.

In some configurations, the Legal Knowledge system 106 can also facilitate collaboration by permitting users to share user created content in addition to user created documents, such as selected quotations, Quote Bundles, and annotations. For example, multiple users can add quotations and/or annotations to a single Quote Bundle or multiple users can edit a user created document. Furthermore, adding annotations, shaping Quote Bundles, and editing user created documents does not have to be limited to users that naturally form a work group, such as co-workers at a law firm. In some configurations, a user can add user created content to content originally created by an unfamiliar user. For example, a user can add a tag to a quotation collected by another user or add a quotation to a Quote Bundle created by another user. The additional user created content can help further shape the legal knowledge base.

The user created content, such as annotations, can be used to create a running commentary on a case, quotation, particular law, etc. This commentary can be created passively through the annotations that are directly connected to a legal document. Alternatively, the commentary can be actively created by adding annotations that directly discuss the content or by adding annotations that comment on other annotations. This can have the effect of creating different topic threads. In some configurations, the user can customize the display of the commentary. For example, in some cases, the user can expand and collapse a topic thread or the user can choose to only display annotations that are directly connected to a legal document or text within a legal document. Using the annotation feature in this manner allows the users to collectively create an understanding of the current state of the law. As the law evolves, users can add new annotations that reflect the changes.

As discussed throughout the description of the Legal Knowledge system 106 and its features, access rights can be assigned to the user created content. The access rights can establish the boundaries of the allowable collaboration and the influence that the various forms of user created content can have in shaping the legal knowledge base within the Legal Knowledge system 106.

### 3. Usage

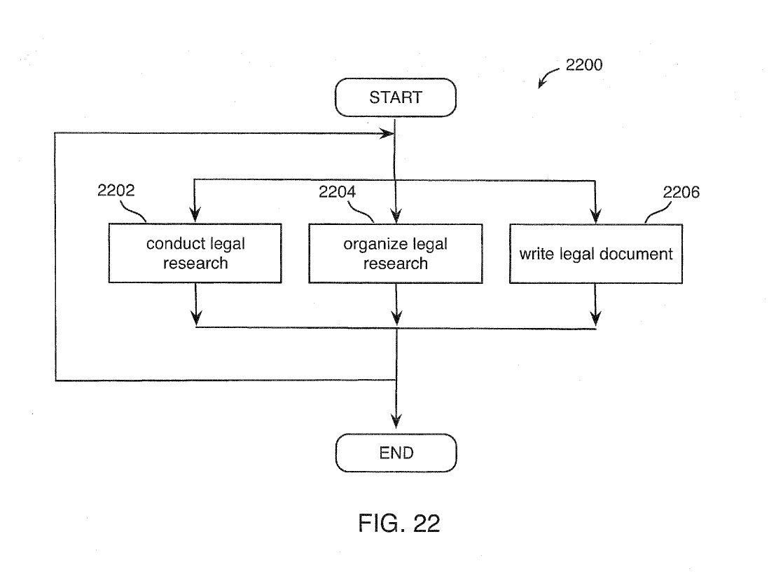

The Legal Knowledge system 106 provides a variety of features that facilitate legal research and writing tasks. FIG. 22 is a flowchart illustrating an exemplary method 2200 for conducting legal research and writing. For the sake of clarity, this method is discussed in terms of an exemplary system such as is shown in FIG. 1. Although specific steps are shown in FIG. 22, in other embodiments a method can have more or less steps than shown. In conducting legal research and writing, a legal researcher can enter the method at any one of three general steps: conducting legal research (2202), organizing legal research (2204), or writing a legal document (2206). In some cases, a legal researcher may begin the method 2200 by focusing strictly on conducting legal research (2202). Once the legal researcher has finished the research phase, the legal researcher may then take the research and organize it (2204). Finally, the legal researcher may use the organized research in writing a legal document, such as a brief or law review article.

In some cases, the legal researcher may repeatedly cycle through multiple steps of the legal research and writing method 2200. For example, the legal researcher may conduct research (2202) on a discrete sub-topic, then organize that research (2204), and then write a portion of the legal document (2206). After, the legal researcher has completed writing on the discrete topic, the legal researcher can return to the research and organizing steps 2202 and 2204. Alternatively, the legal researcher may intertwine the research and organizing steps 2202 and 2204. For example, the legal researcher may conduct a single search and organize the results from that search. Then conduct another search or follow a document path using the document tree and organize those results. This process can be repeated a number of times until the researcher determines that he or she has obtained enough information to begin writing at least a portion of the legal document. After writing at least a portion of the legal document, the legal researcher can return to the research and organizing steps.

In some cases, the legal researcher may begin with the writing step 2206. This can occur for a variety of reasons. For example, the legal researcher is collaborating with one or more other legal researchers who have already, at least minimally, obtained and organized some legal research and/or started writing the legal document. Alternatively, the legal researcher may begin the legal research and writing method 2200 by selecting a template or laying out the format and/or outline of the legal document. The legal researcher may possibly add some initial thoughts, an introduction, some boilerplate text, etc., to the legal document. After some initial writing, the legal researcher may progress to the research and/or organizing steps 2202 and 2204.

In some cases, the legal researcher may interact with the Legal Knowledge system 106 without performing all three steps of the legal research and writing method 2200. For example, the legal researcher may write a legal document (2206) without conducting any legal research or organizing any research. This can occur when the legal researcher is writing a document that does not require any research; when the legal researcher is re-using legal research that has previously been conducted and/or organized, either by the legal researcher or by another user of the Legal Knowledge system 106; or when the legal researcher has conducted and/or organized the research using a tool other than the Legal Knowledge system 106. Alternatively, the legal researcher may only conduct legal research (2202) and/or organize legal research (2204) without performing the writing step 2206. This can occur because the legal researcher is conducting research for later use, either by the legal researcher or another legal researcher; the project was abandoned before the writing step 2206; the legal researcher is using another tool to write the document; or any other reason.

In some embodiments, the organized research and/or the document can be exported from the Legal Knowledge system 106. For example, in some cases the research can be organized into Quote Bundles. One or more Quote Bundles can then be exported so that they can be used to facilitate writing a document using another writing tool. Alternatively, the document can be exported so that it can be edited in another tool, submitted to a court, and/or shared with other legal researchers.

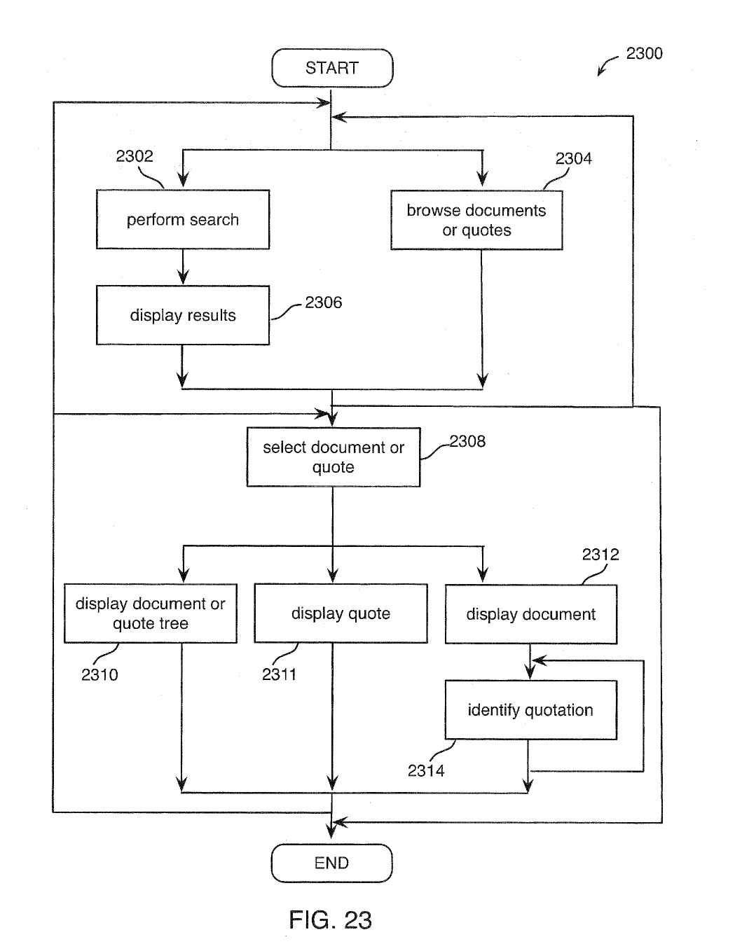

Each step in the legal research and writing method 2200 can involve a number of additional steps. FIGS. 23-25 provide exemplary methods for the research, organizing, and writings steps in method 2200. FIG. 23 is a flowchart illustrating an exemplary method 2300 for conducting legal research. For the sake of clarity, this method is discussed in terms of an exemplary system such as is shown in FIG. 1. Although specific steps are shown in FIG. 23, in other embodiments a method can have more or less steps than shown.

In the research method 2300, the research process can begin by performing a search (2302) or by browsing the available documents or quotations (2304). As described above, the Legal Knowledge system 106 can provide a variety of functionality and different UIs for performing these steps. For example, the search step 2302 can be a keyword search. Based on the entered search terms, the Legal Knowledge system 106 can display the available documents and/or quotations associated with the search terms (2306). In some cases, the search and browse steps 2302 and 2304 can be intertwined, such as in the hybrid browse-search feature described above. Additionally, the search and/or browse steps 2302 and 2304 can be performed repeatedly.

In some cases, after the search and/or browse steps 2302 and 2304, the research method 2300 can end. However, in other cases, the legal researcher can select a document or quotation from the browse or search results (2308). Based on the selected document or quotation, the Legal Knowledge system 106 can display the document or quotation tree (2310). As described above, the document or quotation tree can display the selected document or quotation as well as a number of related items, such as other documents, quotations, Quote Bundles, annotations, etc. This information can be used to facilitate further research, such as by repeating the document or quotation selection step 2308, conducting a new search (2302), or by browsing the displayed documents or quotations (2304). This iterative process can repeat any number of times. Alternatively, the Legal Knowledge system 106 can simply display the selected document or (2312) or quotation (2311). From the displayed document, the user can identify one or more quotations (2314). In some cases, the Legal Knowledge system 106 can automatically associate the proper citation information with the selected quotation. Once the user has finished interacting with the selected document or quotation, a new document or quotation can be selected (2308) or the search and/or browse steps 2302 and 2304 can be repeated.

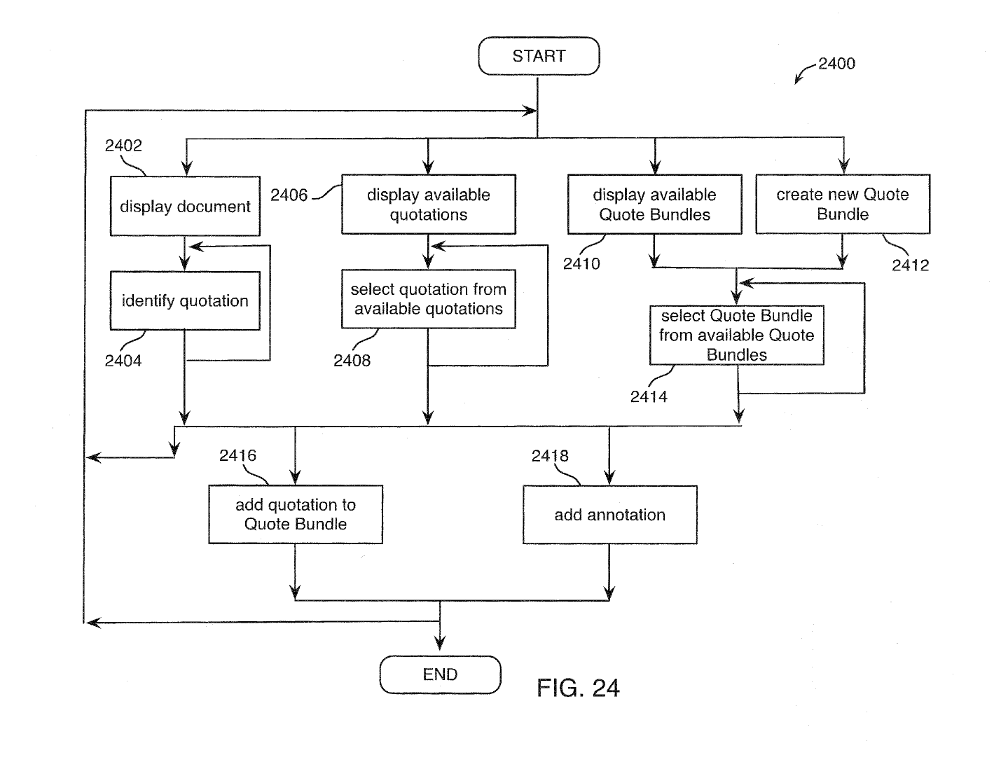

FIG. 24 is a flowchart illustrating an exemplary method 2400 for organizing legal research. For the sake of clarity, this method is discussed in terms of an exemplary system such as is shown in FIG. 1. Although specific steps are shown in FIG. 24, in other embodiments a method can have more or less steps than shown. A number of different steps can mark the beginning of the organization method 2400. In some cases, the Legal Knowledge system 106 can display a document (2402) and one or more quotations can be identified in the document (2404). The Legal Knowledge system 106 can automatically associate the proper citation information with the selected quotation. The one or more quotations can then be used to create a new Quote Bundle (2412) or can be added to an already existing Quote Bundle (2416). When the quotation is added to the Quote Bundle, the proper citation information can continue to be associated with the quotation in the Quote Bundle. In some embodiments, access rights can be assigned to the quotation and/or Quote Bundle.

In some cases, the Legal Knowledge system 106 can display the available quotations (2406) and one or more quotations can be selected (2408). The one or more quotations can then be added to a Quote Bundle (2416) and/or an annotation can be added to the quotation (2418). In some cases, when the quotation is added to the Quote Bundle, the proper citation information and any associated annotations can continue to be associated with the quotation in the Quote Bundle. However, the Legal Knowledge system 106 can also be configured such that none or only a subset of the annotations accompanies the quotation to the Quote Bundle. As described above, the quotations that are available to the user can vary with the configuration of the Legal Knowledge system 106. In some configurations, only the quotations associated with the user are available to the user. However, in some configurations, the Legal Knowledge system 106 can support access rights. Based on the access rights assigned to the quotations in the Legal Knowledge system 106, quotations beyond the user's own quotations may be available.

In some cases, the Legal Knowledge system 106 can display the available Quote Bundles (2410) and one or more Quote Bundles can be selected (2414). As described above, the Quote Bundles that are available to the user can vary with the configuration of the Legal Knowledge system 106. In some configurations, only the Quote Bundles associated with the user are available to the user. However, in some configurations, the Legal Knowledge system 106 can support assigning access rights to the Quote Bundles. Based on the access rights, Quote Bundles beyond the user's own Quote Bundles may be available. After selecting a Quote Bundle, one or more annotations can be added (2418). Additionally, one or more quotations can be selected from a selected Quote Bundle and moved or copied to another selected Quote Bundle. In some cases, when the quotation is moved or copied to the Quote Bundle, the proper citation information and any associated annotations can continue to be associated with the quotation in the second Quote Bundle. However, the Legal Knowledge system 106 can also be configured such that none or only a subset of the annotations accompanies the quotation to the second Quote Bundle.

In some cases, the Legal Knowledge system 106 can create a new empty Quote Bundle (2412). After creating the Quote Bundle, one or more quotations can be selected (2406 and 2408) and added to the new Quote Bundle (2416). The steps of identifying new quotations, selecting quotations, selecting Quote Bundles, adding quotations to Quote Bundles, adding annotations, etc. can be repeated any number of times.

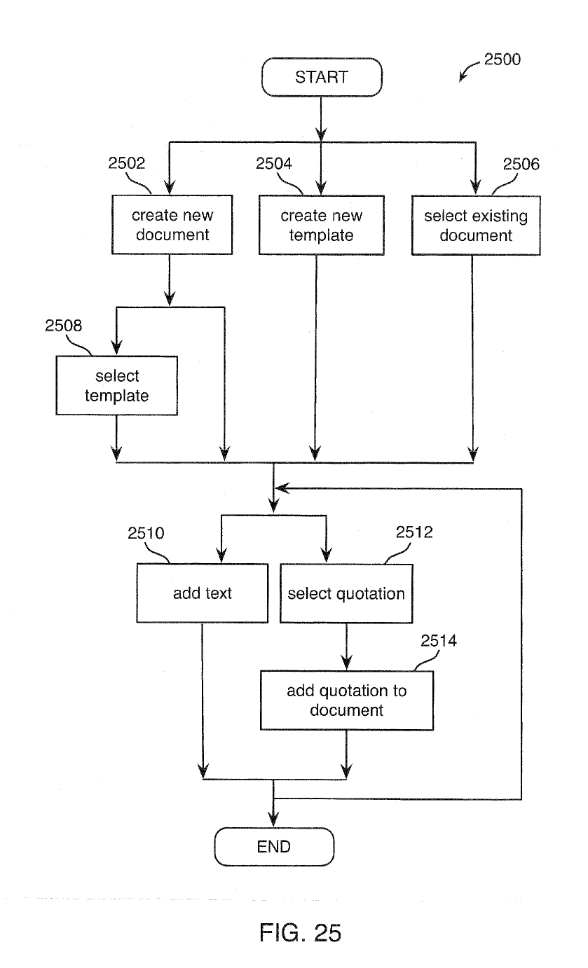

FIG. 25 is a flowchart illustrating an exemplary method 2500 for conducting legal writing. For the sake of clarity, this method is discussed in terms of an exemplary system such as is shown in FIG. 1. Although specific steps are shown in FIG. 25, in other embodiments a method can have more or less steps than shown. The writing method 2500 can begin with one of three different steps: creating a new document (2502), creating a new template (2504), or selecting an existing document (2506). As part of the process of creating a new document, the user can also select from the available templates for the document. For example, the user can select a template for a memorandum or a brief. Each of these steps 2502, 2504, 2506, and 2508 can be followed by the step of adding text to the document (2510). Additionally, a quotation can be selected from the available quotations (2512) and the quotation can be added to the document (2514). The quotation can be selected from a list of available quotations or from a Quote Bundle. Once the quotation has been added to the document, the Legal Knowledge system 106 can automatically add the appropriate citation for the quotation.

In some cases, the steps of adding text and adding quotations can be intertwined and/or repeated. For example, the user may type some text and then drag a quotation to the document and then type some more. Alternatively the user could drag a number of quotations to various places in the document and then add text around the quotations. Any combinations of the steps of adding text (2510) and selecting and adding quotations (2512 and 2514) are possible.

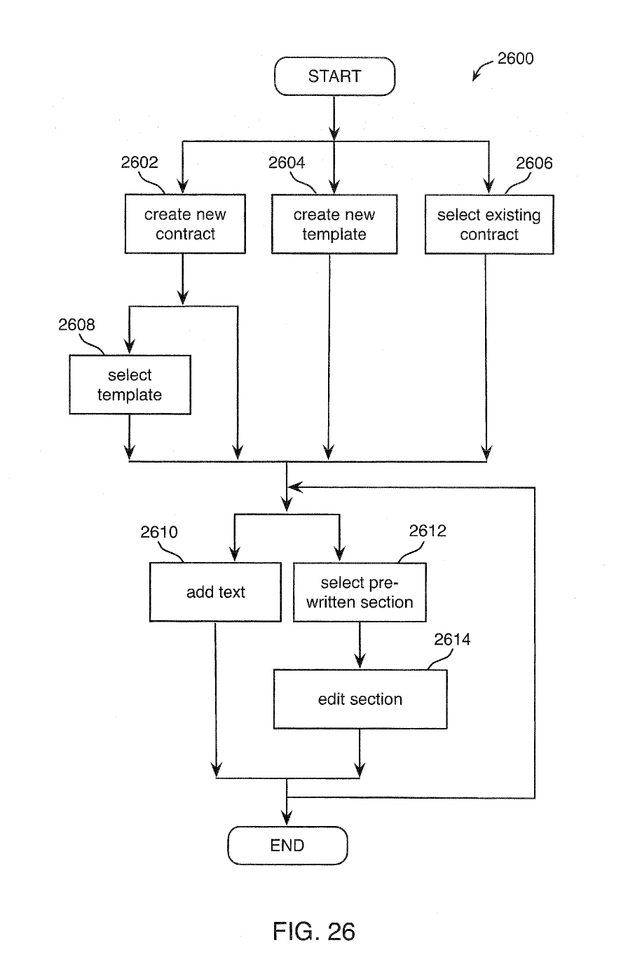

In some embodiments, the Legal Knowledge system 106 can provide functionality specific to the task of writing a contract. Often a contract can be composed of multiple sections obtained from one or more previously written contracts. In some cases, the previously written sections can be used as-is, while, in other cases, minor edits are required. FIG. 26 is a flowchart illustrating an exemplary method 2600 for writing a contract. For the sake of clarity, this method is discussed in terms of an exemplary system such as is shown in FIG. 1. Although specific steps are shown in FIG. 26, in other embodiments a method can have more or less steps than shown.

The contract writing method 2600 can begin with one of three different steps: creating a new contract from scratch (2602), creating a new template (2604), or selecting an existing contract (2606). As part of the process of creating a new contract from scratch, the user can also select from the available templates for the document. In some embodiments, a new contract document can be completely empty, while, in other cases, a new contract can automatically contain a standard set of boilerplate sections.

Each of the steps 2602, 2604, 2606, and 2608 can be followed by the step of adding text to the contract (2610). Additionally, a pre-written contract section/clause can be selected and added to the contract (2612). In some cases the pre-written section will require editing to customize the text for the purpose of the contract (2614).

In some cases, the steps of adding text and adding pre-written sections/clauses can be intertwined and/or repeated. For example, the user may type some text and then drag a section to the contract and then type some more. Alternatively the user could drag a number of sections to various places in the document and then add text around the pre-written sections. Any combinations of the steps of adding text (2610) and selecting and editing pre-written sections (2612 and 2614) are possible.

In some configurations, users can add annotations to the different contract templates and/or pre-written contract clauses/sections. The annotations can be used to aid a user in selecting an appropriate template or clause/section. For example, an annotation can discuss a strength or weakness of a clause. Alternatively, an annotation can be used to explain when to use a particular clause. As another example, an annotation can also be used to indicate that a particular template is better suited for agreements between natural persons or that it is drafted for a particular type of transaction, such as real estate transactions. An annotation may also be used to indicate a user's experience with a template or clause, such as points of ambiguity or areas that were sticking points in the negotiation process. The annotation may further note the changes required by the parties that eliminated the ambiguity or disagreement. Such annotations can aid future users by allowing them to anticipate difficulties and make adjustments to their contract.

### 4. Exemplary System

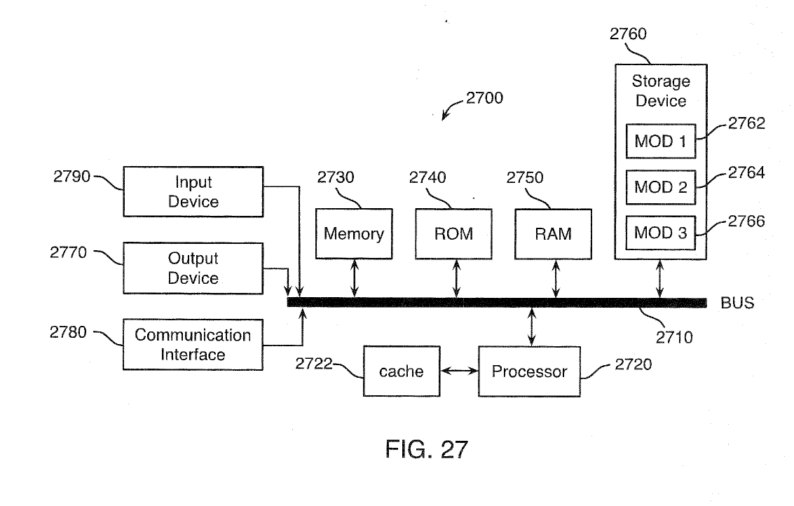

With reference to FIG. 27, an exemplary system 2700 includes a general-purpose computing device 2700, including a processing unit (CPU or processor) 2720 and a system bus 2710 that couples various system components including the system memory 2730 such as read only memory (ROM) 2740 and random access memory (RAM) 2750 to the processor 2720. The system 2700 can include a cache 2722 of high speed memory connected directly with, in close proximity to, or integrated as part of the processor 2720. The system 2700 copies data from the memory 2730 and/or the storage device 2760 to the cache 2722 for quick access by the processor 2720. In this way, the cache 2722 provides a performance boost that avoids processor 2720 delays while waiting for data. These and other modules can be configured to control the processor 2720 to perform various actions. Other system memory 2730 may be available for use as well. The memory 2730 can include multiple different types of memory with different performance characteristics. It can be appreciated that the disclosure may operate on a computing device 2700 with more than one processor 2720 or on a group or cluster of computing devices networked together to provide greater processing capability. The processor 2720 can include any general purpose processor and a hardware module or software module, such as module 1 2762, module 2 2764, and module 3 2766 stored in storage device 2760, configured to control the processor 2720 as well as a special-purpose processor where software instructions are incorporated into the actual processor design. The processor 2720 may essentially be a completely self-contained computing system, containing multiple cores or processors, a bus, memory controller, cache, etc. A multi-core processor may be symmetric or asymmetric.

The system bus 2710 may be any of several types of bus structures including a memory bus or memory controller, a peripheral bus, and a local bus using any of a variety of bus architectures. A basic input/output (BIOS) stored in ROM 2740 or the like, may provide the basic routine that helps to transfer information between elements within the computing device 2700, such as during start-up. The computing device 2700 further includes storage devices 2760 such as a hard disk drive, a magnetic disk drive, an optical disk drive, tape drive or the like. The storage device 2760 can include software modules 2762, 2764, 2766 for controlling the processor 2720. Other hardware or software modules are contemplated. The storage device 2760 is connected to the system bus 2710 by a drive interface. The drives and the associated computer readable storage media provide nonvolatile storage of computer readable instructions, data structures, program modules and other data for the computing device 2700. In one aspect, a hardware module that performs a particular function includes the software component stored in a non-transitory computer-readable medium in connection with the necessary hardware components, such as the processor 2720, bus 2710, output device 2770, and so forth, to carry out the function. The basic components are known to those of skill in the art and appropriate variations are contemplated depending on the type of device, such as whether the device 2700 is a small, handheld computing device, a desktop computer, or a computer server.

Although the exemplary embodiment described herein employs the hard disk 2760, it should be appreciated by those skilled in the art that other types of computer readable media which can store data that are accessible by a computer, such as magnetic cassettes, flash memory cards, digital versatile disks, cartridges, random access memories (RAMs) 2750, read only memory (ROM) 2740, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 2700, an input device 2790 represents any number of input mechanisms, such as a microphone for speech, a touch-sensitive screen for gesture or graphical input, keyboard, mouse, motion input, speech and so forth. An output device 2770 can also be one or more of a number of output mechanisms known to those of skill in the art. In some instances, multimodal systems enable a user to provide multiple types of input to communicate with the computing device 2700. The communications interface 2780 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 2720. The functions these blocks represent may be provided through the use of either shared or dedicated hardware, including, but not limited to, hardware capable of executing software and hardware, such as a processor 2720, that is purpose-built to operate as an equivalent to software executing on a general purpose processor. For example the functions of one or more processors presented in FIG. 27 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 2740 for storing software performing the operations discussed below, and random access memory (RAM) 2750 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 2700 shown in FIG. 27 can practice all or part of the recited methods, can be a part of the recited systems, and/or can operate according to instructions in the recited non-transitory computer-readable storage media. Such logical operations can be implemented as modules configured to control the processor 2720 to perform particular functions according to the programming of the module. For example, FIG. 27 illustrates three modules Mod1 2762, Mod2 2764 and Mod3 2766 which are modules controlling the processor 2720 to perform particular steps or a series of steps. These modules may be stored on the storage device 2760 and loaded into RAM 2750 or memory 2730 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A method of legal document formulation and accumulating legal knowledge comprising:
designating an anchor, the anchor being a heading, a citation, or a document passage identifiable by a server;
accepting commentary related to the anchor;
associating the commentary with the anchor;
arranging the anchor and associated commentary at a position within an editor in response to an input depositing the anchor at the position;
saving the anchor and commentary to the server; and
retrieving the anchor and commentary as a search result.

2. The method of claim 1, further comprising:
associating the commentary and anchor with a collection of users, wherein the collection of users can retrieve the anchor and commentary as a search result.

3. The method of claim 1, further comprising:
searching for the anchor, the anchor being associated with a plurality of discrete items of commentary, wherein retrieving the anchor also retrieves the plurality of discrete items of commentary.

4. The method of claim 1, wherein the anchor is multiple anchors, each anchor being paired with its associated commentary, the arranging further including arranging the multiple anchors and commentary pairs within the editor amongst each other.

5. The method of claim 1, wherein arranging the anchor and associated commentary forms a bundle of related information.

6. The method of claim 1, wherein arranging the anchor inserts the anchor, with available citation information in proper citation format, in a user created document.

7. A system comprising:
a processor;
a network interface;
a first module configured to control the processor to receive, via the network interface, a request from a user to designate an anchor, the anchor being a heading, a citation, or a document passage;
a second module configured to control the processor to accept commentary related to the anchor;
a third module configured to control the processor to arrange the anchor and associated commentary at a position within an editor in response to receiving input from a user;
a fourth module configured to control the processor to save the anchor and commentary; and
a fifth module configured to control the processor to retrieve the anchor and commentary as a search result.

8. The system of claim 7, further comprising:
a sixth module configured to control the processor to associate the commentary and anchor with a collection of users, wherein the collection of users can retrieve the anchor and commentary as a search result.

9. The system of claim 7, further comprising:
a sixth module configured to control the processor to search for the anchor, the anchor being associated with a plurality of discrete items of commentary, wherein retrieving the anchor also retrieves the plurality of discrete items of commentary.

10. The system of claim 7, wherein the anchor is multiple anchors, each anchor being paired with its associated commentary, the arranging further including arranging the multiple anchors and commentary pairs within the editor amongst each other.

11. The system of claim 7, wherein arranging the anchor and associated commentary forms a bundle of related information.

12. The system of claim 7, wherein arranging the anchor inserts the anchor, with available citation information in proper citation format, in a user created document.

13. A non-transitory computer-readable storage medium storing instructions which, when executed by a computing device, cause the computing device to formulate a legal document and accumulate legal knowledge, the instructions comprising:
identifying a quotation in a document;
associating a citation with the identified quotation;
adding the quotation to a bundle user interface element;
associating an annotation with the quotation, the annotation being additional content accepted into the bundle; and
saving the bundle of related information including the quotation, citation, and annotation while maintaining the association between the quotation and the citation and the annotation.

14. The non-transitory computer-readable storage medium of claim 13, where the annotation can be at least one of an editable annotation, a definition annotation, a relational annotation, a note annotation, or a tag annotation.

15. The non-transitory computer-readable storage medium of claim 13, further comprising:
associating the bundle of related information with a collection of users, wherein the collection of users can retrieve the bundle as a search result.

16. The non-transitory computer-readable storage medium of claim 13, further comprising:
selecting a quotation from the bundle; and
inserting the quotation in a user created document;

17. The non-transitory computer-readable storage medium of claim 16, wherein inserting the quotation further comprises inserting an associated citation information in the user created document in a proper citation format.

18. The non-transitory computer-readable storage medium of claim 13, further comprising:
searching for the quotation and, when retrieving the quotation also retrieving the associated annotation and citation.

19. The non-transitory computer-readable storage medium of claim 13, further comprising:
selecting a quotation from a set of available quotations; and
displaying information related to the selected quotation in a manner that reflects a relationship between the quotation and an item of related information.

20. The non-transitory computer-readable storage medium of claim 19, wherein information related to the selected quotation can be at least one of a document that cites the quotation, a document that the quotation cites, a bundle.
